(19) United States
(12) Patent Application Publication
(10) Pub. No.: US 2016/0269175 A1
(43) Pub. Date: Sep. 15, 2016

(54) CRYPTOGRAPHIC CIPHER WITH FINITE SUBFIELD LOOKUP TABLES FOR USE IN MASKED OPERATIONS

(71) Applicant: QUALCOMM Incorporated, San Diego, CA (US)

(72) Inventors: Rosario Cammarota, San Diego, CA (US); Olivier Jean Benoit, San Diego, CA (US); Anand Palanigounder, San Diego, CA (US)

(21) Appl. No.: 14/642,591

(22) Filed: Mar. 9, 2015

(51) Int. Cl. H04L 9/06

(52) U.S. Cl. CPC H04L 9/0631; H04L 2209/24; H04L 2209/34

(57) ABSTRACT

Various features pertain to cryptographic ciphers such as Advanced Encryption Standard (AES) block ciphers. In some examples described herein, a modified masked AES SubBytes procedure uses a static lookup table that is its own inverse in GF(2²). The static lookup table facilitates computation of the multiplicative inverse during nonlinear substitution operations in GF(2²) In an AES encryption example, the AES device combines plaintext with a round key to obtain combined data, then routes the combined data through an AES SubBytes substitution stage that employs the static lookup table and a dynamic table to perform a masked multiplicative inverse in GF(2²) to obtain substituted data. The substituted data is then routed through additional cryptographic AES stages to generate ciphertext. The additional stages may include further SubBytes stages that also exploit the static and dynamic tables. Other examples employ either a static lookup table or a dynamic lookup table but not both.

### BACKGROUND

1. Field of the Disclosure

Various features relate to ctyptographic ciphers for encryption and decryption, particularly Advanced Encryption Standard (AES) ciphers or other symmetric ciphers.

2. Description of Related Art

The Advanced Encryption Standard (AES) was established by the U.S. National institute of Standards and Technology (NIST) in 2001 for use in the encryption and decryption of electronic data using symmetric keys, i.e., the same key is used for encryption and decryption. Some implementations of AES exploit finite field algebra on Galois Fields (GF) such as GF(2⁸). An AES cipher typically begins with an initial AddRoundKey operation in which each byte of a current “state” of the plaintext to be encrypted is combined with a round key (derived from a main cipher key). The “state” is a 4×4 matrix of bytes. Thereafter, each encryption round usually includes four main stages: (1) a SubBytes stage, which is a non-linear substitution step where each byte is replaced with another according to a lookup table (i.e. an “S-box”) or other suitable substitution guide; (2) a ShiftRows stage, which is a transposition step where the last few rows of the state are shifted cyclically a certain number of steps; (3) a MixColumns stage, which is a mixing operation that operates on the columns of the state, combining the four bytes in each column: and (4) another AddRoundKey stage. It is noted that the numbering of the stages could be arbitrary and one might instead refer to the initial AddRoundKey stage as the “first” stage, so that the SubBytes step is the “second” stage.

A challenge in designing a practical AES hardware device is to achieve an effective tradeoff between compactness and performance, where overall performance is affected by processing speed as well as other factors such as security, e,g., immunity to side-channel channel attacks that seek to obtain the cipher key. To improve security and protect from attacks, masking operations may be performed, particularly during the SubBytes stage. Masking is a countermeasure against side-channel attacks that involves randomizing the internal state of a cipher so that the observation of few intermediate values during encryption or decryption will not provide information about any of the sensitive variables such as the secret key. To accommodate masking in AES, a multiplicative inverse operation may be performed) that utilizes an 8-bit random number generator along with additional circuitry such as dynamic look-up tables.

It would be useful to modify the SubBytes stage (and any corresponding InvSubBytes stages) within masked AES systems to improve processing efficiency without reducing security and/or provide similar modifications within the corresponding substitution stages of other ciphers that exploit finite field algebra.

### SUMMARY

A method operational in a cryptographic device includes: combining, as part of a cryptographic operation, input data with a round key to obtain combined data; routing at least a portion of the combined data through a substitution stage employing at least one of a static lookup table that is its own inverse in a subfield of a finite field to obtain substituted data, a dynamic lookup table in the subfield of the finite field where all substitution operations are implemented using permutations to obtain the substituted data, or an alternative static lookup table in the subfield of the finite field that statically stores all permutations needed to obtain the substituted data; and routing the substituted data through one or more additional cryptographic stages to generate an output data.

In another aspect, a cryptographic device includes: a processing circuit configured to combine, as part of a cryptographic operation, input data with a round key to obtain combined data; route at least a portion of the combined data through a substitution stage employing at least one of a static lookup table that is its own inverse in a subfield of a finite field to obtain substituted data, a dynamic lookup table in the subfield of the finite field where all substitution operations are implemented using permutations to obtain the substituted data, or an alternative static lookup table in the subfield of the finite field that statically stores all permutations needed to obtain the substituted data; and route the substituted data through one or more additional cryptographic stages to generate an output data; and a storage device configured to store the output data.

In yet another aspect, a cryptographic device includes: means for combining, as part of a cryptographic operation, input data with a round key to obtain combined data; means for routing at least a portion of the combined data through a substitution stage employing at least one of a static lookup table that is its own inverse in a subfield of a finite field to obtain substituted data, a dynamic lookup table in the subfield of the finite field where all substitution operations are implemented using permutations to obtain the substituted data, or an alternative static lookup table in the subfield of the finite field that statically stores all permutations needed to obtain the substituted data; and means for routing the substituted data through one or more additional cryptographic stages to generate an output data.

In still yet another aspect, a machine-readable storage medium for use with cryptography includes one or more instructions which when executed by at least one processing circuit causes the at least one processing circuit to: combine, as part of a cryptographic operation, input data with a round key to obtain combined data; route at least a portion of the combined data through a substitution stage employing at least one of a static lookup table that is its own inverse in a subfield of a finite field to obtain substituted data, a dynamic lookup table in the subfield of the finite field where all substitution operations are implemented using permutations to obtain the substituted data, or an alternative static lookup table in the subfield of the finite field that statically stores all permutations needed to obtain the substituted data; and route the substituted data through one or more additional cryptographic stages to generate an output data.

### BRIEF DESCRIPTION OF THE DRAWINGS

FIG. 1 illustrates exemplary masked AES encryption and decryption systems and methods employing masked SubBytes and InvSubBytes operations.

FIG. 2 illustrates an exemplary masked SubBytes processor for use with the AES systems and methods of FIG. 1.

FIG. 3 illustrates exemplary procedures for use by an AES cryptographic device to exploit a static lookup table that is its own inverse to facilitate masked substitution operations such as SubBytes or InvSubBytes.

FIG. 4 illustrates an exemplary system-on-a-chip (SoC) of a mobile device wherein the SoC includes an AES processor with a static lookup table that is its own inverse to facilitate masked substitution operations for encryption/decryption.

FIG. 5 illustrates exemplary masked AES encryption and decryption systems and methods employing masked SubBytes and InvSubBytes operations that exploit GF(2²) static and dynamic lookup tables.

FIG. 6 illustrates an exemplary masked SubBytes processor for use with the AES systems and methods of FIG. 5 where the SubBytes processor exploits GF(2²) static and dynamic lookup tables.

FIG. 7 illustrates an exemplary masked inversion in GF(2²) for AES SubByte processing that exploits static and dynamic lookup tables.

FIG. 8 illustrates exemplary components of a masked SubBytes processor that exploits static and dynamic lookup tables in GF(2²).

FIG. 9 is a block diagram illustrating an example of a hardware implementation for an apparatus employing a processing system that may exploit the systems, methods and apparatus of FIGS. 3-8.

FIG. 10 is a block diagram illustrating exemplary components of the processing circuit of FIG. 9 for use with a hybrid implementation where both static and dynamic tables are employed in the substitution stage.

FIG. 11 is a block diagram illustrating exemplary instruction components of the machine-readable medium of FIG. 9.

FIG. 12 summarizes exemplary procedures for use by a cryptographic device.

FIG. 13 summarizes additional exemplary procedures for use by a cryptographic device, particularly an AES block cipher.

FIG. 14 is a block diagram illustrating exemplary components of the processing circuit of FIG. 9 for use with an implementation where a dynamic table is employed in the substitution stage without a corresponding static table.

FIG. 15 is a block diagram illustrating exemplary instruction components of the machine-readable medium of FIG. 14.

FIG. 16 is a block diagram illustrating exemplary components of the processing circuit of FIG. 9 for use with an implementation where a static table is employed in the substitution stage without a corresponding dynamic table.

FIG. 17 is a block diagram illustrating exemplary instruction components of the machine-readable medium of FIG. 14.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation.

### Overview

Several novel features pertain to devices and methods for use with cryptographic systems, such as systems configured in accordance with AES.

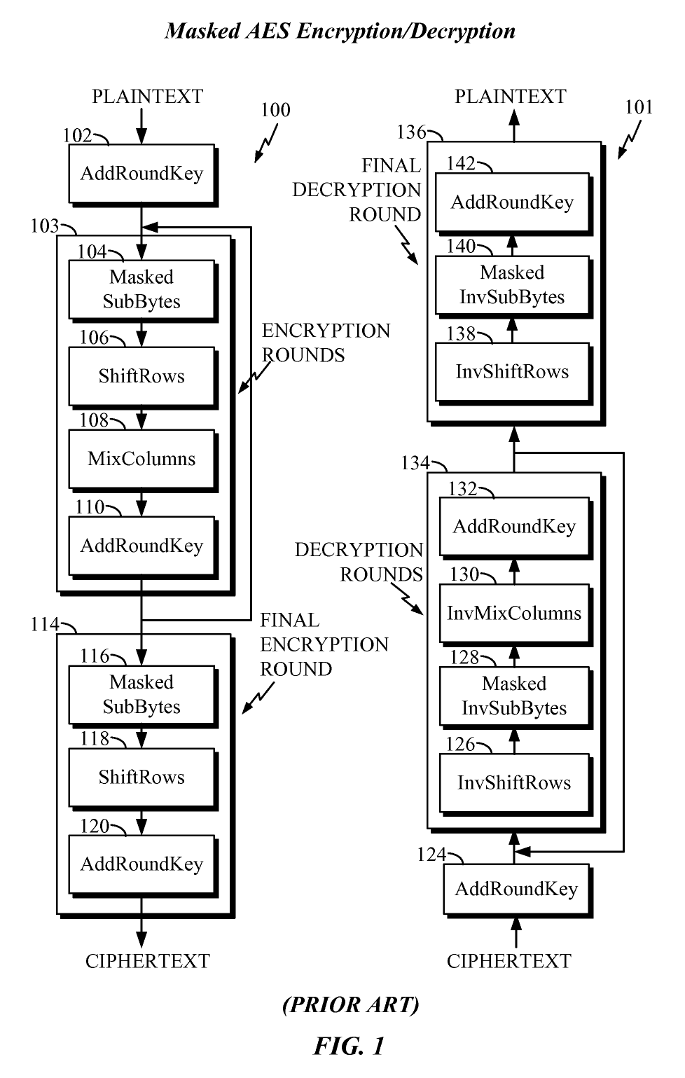

FIG. 1 illustrates the stages of an exemplary AES system for encryption 100 and decryption 101 where masking is employed during SubBytes and InvSubBytes stages, which are byte substitution stages. For encryption, beginning at 102, an initial AddRoundKey operation is performed on input plaintext, wherein each byte of the current state is combined with a block of a round key. As noted above, the “state” is a 4×4 matrix of bytes. That is, during AddRoundKey, a subkey is derived from a main key using, e.g., Rijndael's key schedule where each subkey is the same size as the state. The subkey is then added in by combining each byte of the state with a corresponding byte of the subkey using bitwise XOR. Following the initial AddRoundKey operation, encryption rounds 103 are performed where each round includes a Masked SubBytes stage 104, a ShiftRows stage 106, a MixColumns 108 stage and another AddRoundKey stage 110. The Masked SubBytes stage 104 is a masked version of a standard AES SubBytes stage. In a Masked SubBytes stage, each byte in the state matrix is replaced with a corresponding SubByte using a substitution device or processor where masking is provided. The masked substitution provides non-linearity in the cipher while also acting as a countermeasure to side-channel attacks. In some conventional examples of AES, the SubBytes device computes a multiplicative inverse over GF(2⁸) where GF(2⁸)is a Galois Field (i.e. a Finite Field). As will be described below, modified versions can instead perform the multiplicative inverse using the GF(2²) subfield. Following completion of the encryption rounds 103, a final encryption round 114 is performed, which includes a final Masked SubBytes stage 116, a final ShiftRows stage 118 and a final AddRoundKey stage 120. The output is the encrypted ciphertext.

Decryption 101 operates in reverse to convert ciphertext to plaintext. Briefly, beginning at 124, an initial AddRoundKey operation is performed on the input ciphertext, wherein each byte of the current state is combined with a block of a round key. Following the initial AddRoundKey operation, decryption rounds 134 are performed where each round includes an InvShiftRows stage 126, a Masked InvSubBytes substitution stage 128, an InvMixColumns stage 130 and another AddRoundKey stage 132. The Masked InvSubBytes stage 104 is a modified version of a standard AES InvSubBytes stage. Following decryption rounds 134, a final decryption round 136 is performed, which includes a final InvShiftRows stage 138, a final Masked InvSubBytes substitution stage 140 and a final AddRoundKey stage 136, the output of which is the decrypted plaintext.

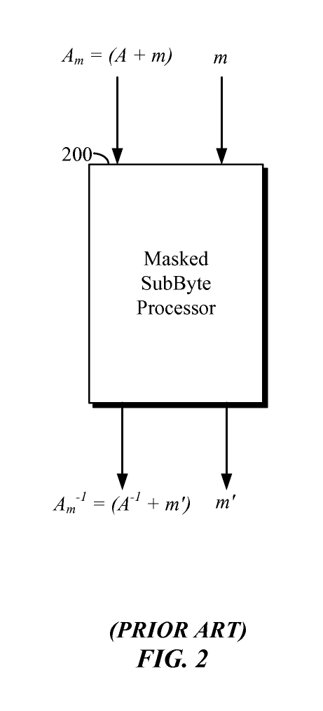

FIG. 2 illustrates a Masked SubByte substitution device or processor 200, which receives two inputs: Aₘ=(A+m) and m, i.e. a masked value Aₘ and an input mask in where A represents one byte of a current state of data to be encrypted. The output is a masked inverse Aₘ⁻¹ and an output mask m¹, where the masked inverse may be represented by Aₘ⁻¹=(A⁻¹+m¹). Implementing the Masked SubByte processor 200 typically requires the SubByte circuity to perform a multiplicative inverse and an affine transform. For GF(2⁸), the SubByte operation employs two main sub-steps: (1) compute the inverse of an element or byte of the field and (2) multiply the resulting inverse (represented as a vectors of bits in GF(2⁸)) by a bit matrix and add a constant vector so as to perform an affine transformation. These operations may exploit various random bits that are not shown in FIG. 2 and are generated internally by the processor 200. Computing the inverse can be computationally expensive in terms of time and/or circuit area. For a GF implementation of AES, a byte may be regarded as a polynomial where the bits are coefficients of corresponding powers of the polynomial and multiplication is modulo an irreducible polynomial. However, instead of using a vector of dimension eight over GF(2⁴), one can instead define a byte to represent a vector of dimension two over GF(2⁴) where each 4-bit element is a vector of dimension two over GF(2²) and each 2-bit element is a vector of dimension two over GF(2). This may be referred to as a composite field or tower field representation. As such, an 8-bit inverse operation is converted to several 4-bit operations, each employing 2-bit calculations. See, Canright et al.: A Very Compact “Perfectly Masked” S-Box for AES (corrected). IACR Cryptology ePrint Archive 2009: 11 (2009). Composite or tower field techniques may be applied to masked SubByte operations as well as unmasked SubBytes.

In addition to the aforementioned components for computing the multiplicative inverse, the conventional masked SubByte processor includes an 8-bit random number generator and additional circuitry that may depend on the particular implementation. For example, a lookup table may be provided to facilitate certain operations, although this typically requires additional memory and hence consumes more circuit space. As noted, with composite field arithmetic, operations are performed using subfields of the field over which the AES operations are performed. In this regard, the computation of the multiplicative inverse for use with composite field arithmetic typically requires: the generation of new random hits, e,g., six more in the case of Canright-like implementations in GF(2²) and additional operations in parallel to the critical path to compute correction terms for GF(2²) and GF(2⁴). Additional operations are also typically provided on the critical path to improve security and apply the correction terms. For various Canright-like implementations, see also: Canright, A Very Compact S-Box for AES. CHES 2005; Canright, A Very Compact Rijndael S-box, Naval Postgraduate School Technical Report: NPS-MA-05-001; Canright: Avoid Mask Re-use in Masked Galois Multipliers. IACR Cryptology ePrint Archive 2009:12 (2009),

For an exemplary non-masked inversion in GF(2²), circuitry is provided within the AES device to compute the following based on inputs of B=[b₁, b₀] where b₁ and b₀ are two two-bit pairs, i.e., b₁=(b₁₁, b₁₀) and b₀=(b₀₁, b₀₀):

$$\begin{matrix}Intermediate computation \text{:} c = n \times {( {b}_{1} + {b}_{0} )}^{2} + ( {b}_{1} \times {b}_{0} ) & ( 1 ) \\ Intermediate computation \text{:} {c}^{- 1} = {c}^{2} & ( 2 ) \\ Final result \text{:} {B}^{- 1} = [ \begin{matrix}p \\ q\end{matrix} ] = [ \begin{matrix}{b}_{0} \times {c}^{- 1} \\ {b}_{1} \times {c}^{- 1}\end{matrix} ] & ( 3 )\end{matrix}$$

In these equations, n is a constant and c is a consolidation value. Note that the “×” and “+” operations in these equations denote multiplication and addition operations, respectively, in a Galois Field and hence are not ordinary arithmetic operations. Specifically, the operations (1), (2) and the computation of p and q are multiplications in GF(2²), where p and q are the upper and lower part of B⁻¹ and B⁻¹ is an element of GF(2²).

For an exemplary masked inversion in GF(2²), circuitry is instead provided to perform the following operations with inputs of Bₘ=[b₁ₘ, b₀ₘ], [q₁ₘ, q₀ₘ]:

$$\begin{matrix}Intermediate computation \text{:} {c}_{m} = r + n \times {( {b}_{1 m} + {b}_{0 m} )}^{2} + ( {b}_{1 m} \times {b}_{0 m} ) ++ n \times {( {q}_{1} + {q}_{0} )}^{2} + ( {q}_{1} + {q}_{0} ) ++ ( {b}_{1 m} \times {q}_{0} ) + ( {b}_{0 m} \times {q}_{1} ) & ( 4 ) \\ Intermediate computation \text{:} {c}_{m}^{- 1} = {c}_{m}^{2} & ( 5 ) \\ Final result \text{:} {B}_{m}^{- 1} = [ \begin{matrix}{p}_{m} \\ {q}_{m}\end{matrix} ] = [ \begin{matrix}{t}_{1} + {b}_{0 m} \times {c}_{m}^{- 1} + {b}_{0 m} + {r}^{2} + {q}_{0} \times {c}_{m}^{- 1} + {q}_{0} \times {r}^{2} \\ {t}_{0} + {b}_{1 m} \times {c}_{m}^{- 1} + {b}_{1 m} \times {r}^{2} + {q}_{1} \times {c}_{m}^{- 1} + {q}_{1} \times {r}^{2}\end{matrix} ] & ( 6 )\end{matrix}$$

In these equations, a₁ₘ, q₀ₘ represent two two-bit input mask values; b₁ₘ, b₀ₘ represent two two-bit masked input values (i.e. these are GF(2²) components of a masked input byte Aₘ as shown in FIG. 2); n is again a constant; r is a two two-bit fresh mask and tᵢ is also a two-bit fresh mask. The intermediate values cₘ are consolidated values and is computed with the execution of a secure masked inversion. The r and tᵢ fresh masks are generated internally by processor 200 using a random number generator and are added in the consolidation stage to improve security since, without them, there may be leakage of information during the computations. In the final result, the term beginning b₀ₘ+r²+. . . is a correction term. Likewise, in the final result, the term beginning b₁ₘ×r²+. . . is also a correction term. Note again that the “×” and “+” operations in these equations denote multiplication and addition operations, respectively, in a Galois Field, Similarly to the computation of cₘ⁻¹, the computation of pₘ and pₘ, the upper and lower part of Bₘ⁻¹ are computed using secure multiplications in GF(2²). By performing these operations in GF(2²) rather than in GF(2⁸), the propagation of the mask from input to output is simplified while retaining security because none of the intermediate observable values are correlated with the actual value being computed. However, the computations are fairly complicated and hence are time consuming and, as noted, a random number generator is required to generate the internal fresh bits.

Hence, although the use of composite field arithmetic (e.g. GF(2²)) can reduce the complexity of the multiplicative inversion of SubBytes relative to a standard GF(2⁸) implementation, the Masked SubBytes processor 200 may still require a relatively significant amount of circuit space and consume a relatively significant amount of time, placing a burden on overall performance. The use of a random number generator within the processor can limit its processing speed. Similar concerns apply to the corresponding masked InvSubBytes devices or processors of the decryption portion of AES, which operate as the inverse of the masked SubBytes devices of the encryption portion.

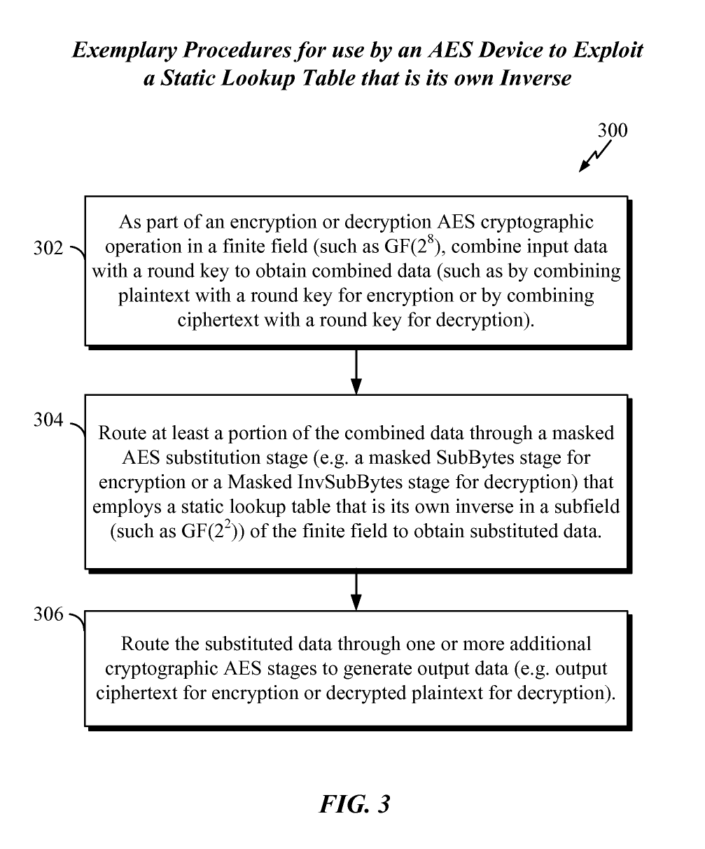

FIG. 3 summarizes a modified substitution procedure 300 that may be used, in at least some implementations, to reduce the number of substitution operations during a SubBytes or InvSubBytes stages of an AES cipher or within corresponding substitution operations of cryptographic devices that exploit composite field operations in a finite field. No random number generator is required to generate internal fresh bits using this procedure, yet security is maintained. By avoiding the use of a random number generator in the SubBytes device, processing speed can be improved relative to devices that compute the results of Equations (4), (5) and (6), above. However, some additional bits may be required along with a static lookup table and a dynamic lookup table in this hybrid implementation. In this regard, the modified SubBytes procedure of FIG. 3 uses a static lookup table that is an inverse of itself in GF(2²) to facilitate the computation of the multiplicative inverse.

Beginning at 302, as part of an encryption or decryption AES cryptographic operation in a finite field (such as GF(2⁸), the AES device combines input text (herein generally referred to as “data”) with a round key to obtain combined data (such as by combining plaintext with a round key for encryption or by combining ciphertext with a round key for decryption). This may correspond, for example, to the initial AddRoundKey operation 102 of FIG. 1 for encryption or to the initial AddRoundKey operation 124 for decryption. Note that, herein, “data” may generally refer to any of various quantities, characters or symbols on which operations are performed by a computing device (such as the AES device or its components). With a computing component that operates in GF(2²), the data is a function of a portion of the status.

At 304 of FIG. 3, the AES device routes at least a portion of the combined data through a masked AES substitution stage (e.g. a masked SubBytes stage for encryption or a Masked InvSubBytes stage for decryption) that employs a static lookup table that is its own inverse in a subfield (such as GF(2²)) of the finite field to obtain substituted data. This may correspond, e.g., to a modified version of the Masked SubBytes operation 104 of FIG. 1 for encryption or to a modified version of the Masked InvSubBytes operation 128 of FIG. 1 for decryption. At 306 of FIG. 3, the AES devices routes the substituted data through one or more additional cryptographic AES stages to generate output data (e.g. output ciphertext for encryption or output decrypted plaintext for decryption). This may correspond to the remaining encryption or decryption stages of FIG. 1.

In one example where the finite field is GF(2⁸) and the subfield is GF(2²), the static lookup table may be represented using one byte in GF(2²) as:

T[·]={00,10,01,11}≡(·)⁻¹ (7)

or its permutations. In addition to the static lookup table, for consolidation, the AES device may exploit a dynamic table Tₘ[·], one byte in size, for use in re-computing the masked terms as soon as the aforementioned correction terms (i.e. input masks) become available. In this example T[·] and Tₘ[·] are distinct tables. Hence, in one example, the input is a correction term (input mask), T[(·)], and current value of the output mask; and the output is Tₘ[·] where Tₘ[·] masked by the current value of the output mask and where its index is corrected by the input mask:

Tₘ[i+correction term]=T[i]+output mask for i=0, 2, 3. (8)

Equation (8) is used for consolidation in place of Equations (4) and (5) above. Hence, in this exemplary implementation of the consolidation stage, the input mask plays the role of the correction term and the output mask is just a permutation of the input mask. The computation of the elements in the dynamic lookup table is performed simultaneously or concurrently with other operations of the SubBytes stage as the correction terms become available. A hybrid implementation with static and dynamic lookup may be used for various intermediate computations and to perform a multiplicative inversion to yield the final results of the masked SubBytes stage.

Note that, at the level of the GF(2²) subfield, the number of permutations is small, i.e. there are only four elements to the GF(2²) subfield. Computing multiplication operations in the GF(2²) subfield corresponds to performing permutations of some of the elements of the subfield (since the subfield is a finite field and hence all multiplication operations in the subfield must yield an element of the subfield). The aforementioned static table can thereby be used to efficiently facilitate the multiplication operations since it stores the various permutations. Moreover, inversion in the subfield is a bit swap. More specifically, in GF(2²): the inverse of 0 is 0; the inverse of 1 is 2; the inverse of 2 is 1; and the inverse of 3 is 3 (where the values 0,1,2 and 3 are meant to represent permissible values of the GF(2²) subfield and not their ordinary arithmetic equivalents). Hence, inversion can easily be performed merely by looking up the inverted value using the static table. Still further, note that an input value plus a correction term (i.e. an input mask) will yield a permutation of the static table. There are only four permutations in GF(2²); the identity table when the input mask is 0 and three other bytes when the input mask is not 0. A permutation is thereby selected by the input mask. The output is selected by using an indexing vector divided by the masked input value in GF(2²). As such, consolidation is conveniently performed without the need for a random number generator or any complicated calculations. The security level is substantially the same as with the predecessor techniques described above because terms are permuted and computed at the same time. Furthermore, with this technique, the number of bits in a byte that are set to one at any given time is always the same. This preserves security by making side-channel attacks difficult (which might otherwise exploit changes in the number of bits set to zero to obtain secret information).

As a concrete example, the following describes an unmasked inverse operation where a table T is used that is its own inverse (and where the numbers are represented in decimal rather than GF(2²) for clarity). For an input value a=2, its inverse, is obtained from table T[a] by looking up the a-th element of the table, which in this example is 1:

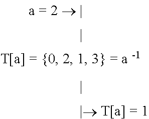

Similarly, T[0]=0, T[1]=2, etc. Hence, the above operation represents the regular (i.e. unmasked) inverse as it might be implemented with lookup table T[·].

With masking, there are three main steps:
(a) All the elements of T[·] are summed simultaneously by the input mask and a dynamic matrix is generated: Tₘ[·]
(b) The elements of Tₘ, are circularly permuted to the left by the amount of the output mask (with the input and the output masks coinciding with one another).
(c) The corresponding output mask is obtained by indexing Tₘ with the input masked value.

The intermediate operation of inversion in GF(2²) was discussed above. For multiplication, the operations are similar, with the main difference being that both permutations to the left and to the right must be allowed. Furthermore, the only elements to permute are those that differ from zero (because a multiplication from zero must return zero). For example, the unmasked multiplication can be synthesized with the following operations (where, again, numbers are represented in decimal for clarity):

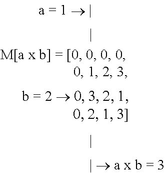

Note that each row/column of M[ ] can be obtained by subsequent permutations of an array containing all the field elements {0, 1, 2, 3}. For example, Each row/column of M[ ] could be obtained by permutations of T[ ]. Consider a single vector MT[ ]={0, 1, 2, 3}. If one of the operands is zero, return zero, otherwise shift left the non-zero elements by b and index the resulting vector by a. For example, if a=1 and b=2, then MT[ ]={0, 3, 1, 2} and MT′ [1]=3, which equals “a x b” in GF(2²),

The outcome of a masked multiplication “(a+m)×(b+m)” may be obtained with the following operations:
(a) if one of the masked elements is zero, return 0.
(b) Otherwise all the non-zero elements of MT′[ ] are summed with the mask in.
(c) All the elements of MT′[ ], except that in position 0, are shifted left by the amount of masked b.
(d) The output—a×b+m—is obtained by indexing the resultant array MT′ by the masked value of a.
   These operations can be achieved with a single additional byte with the capability of shifting to the left and the right or with full sized tables, etc. In the case of multiplication, if one of the two operands is zero, the result of the multiplication must be zero. Note also that, in general, the device sums by the output mask, which in this case can be kept as the input mask, because the addition operations by the mask are done simultaneously. This is also the mechanism which allows for reducing the fresh random bit and reusing the mask in GF(2²). Otherwise, e.g., in a classic Canright-like implementation such would not likely be possible. Also note that MT is different from T. Moreover, MT cannot be obtained from T merely by circular shifting of the elements of T. Likewise T cannot be obtained by circular shift of the elements in MT. However, T can be obtained by permuting the elements in position 1 and 3 of MT and vice-versa.

Hence, the intermediate computations of Equations (4) and (5) are replaced with the aforementioned table lookups and the multiplication operations use the operations just described. Indeed, the number of permutations of values for multiplication is somewhat smaller than those for inversion. Insofar as Equation (6) is concerned, note that the final result Bₘ⁻¹ is composed of two two-bit vectors, pₘ and qₘ, one that begins with t₀ and the other with t₁, which are internally generated fresh bits. To avoid using such fresh bits, the final multiplicative result is based on other permutations, as just described.

The foregoing examples thus describe computations performed on the two two-bits Bₘ of a byte Aₘ, that is being processed by a Masked SubBytes device that employs a hybrid implementation with both dynamic and static tables. Other pairs of bits from Aₘ may be processed sequentially or in parallel using similar components so as to collectively compute the masked inversion of a particular byte. As can be appreciated, many such bytes are processed during the various stages of AES encryption. Relatively small increases in the processing speed of each pair of bits during each SubBytes stage can ultimately yield significant increases in overall processing speed to complete the encryption. Similar considerations apply to the InvSubBytes stages of decryption. Implementations where a dynamic lookup table is employed without a static table are also described herein, as well as implementations where a static lookup table is employed without a dynamic table are also described herein.

These and other features will now be described with reference to exemplary implementations where an AES processing device is a component of a System-on-a-Chip (SoC) processor within a smartphone or similar user access terminal device. Within such devices, circuit area may be limited and hence an AES processor that consumes minimal circuit area while nevertheless achieving adequate security at high processing speeds may be crucial. However, aspects of the cryptographic system can be exploited in a wide variety of systems and devices and may typically be implemented wherever AES or similar cryptographic processing is employed. For example, other hardware environments in which the cryptographic system may be implemented include smartcards or various other storage or communication devices and components or peripheral devices for use therewith. Within smartcards, in particular, circuit space is limited and clock speeds may be relatively show, thus benefiting from an AES device that does not consume significant circuit space, yet operates quickly and efficiently.

### Exemplary SoC Hardware Environment

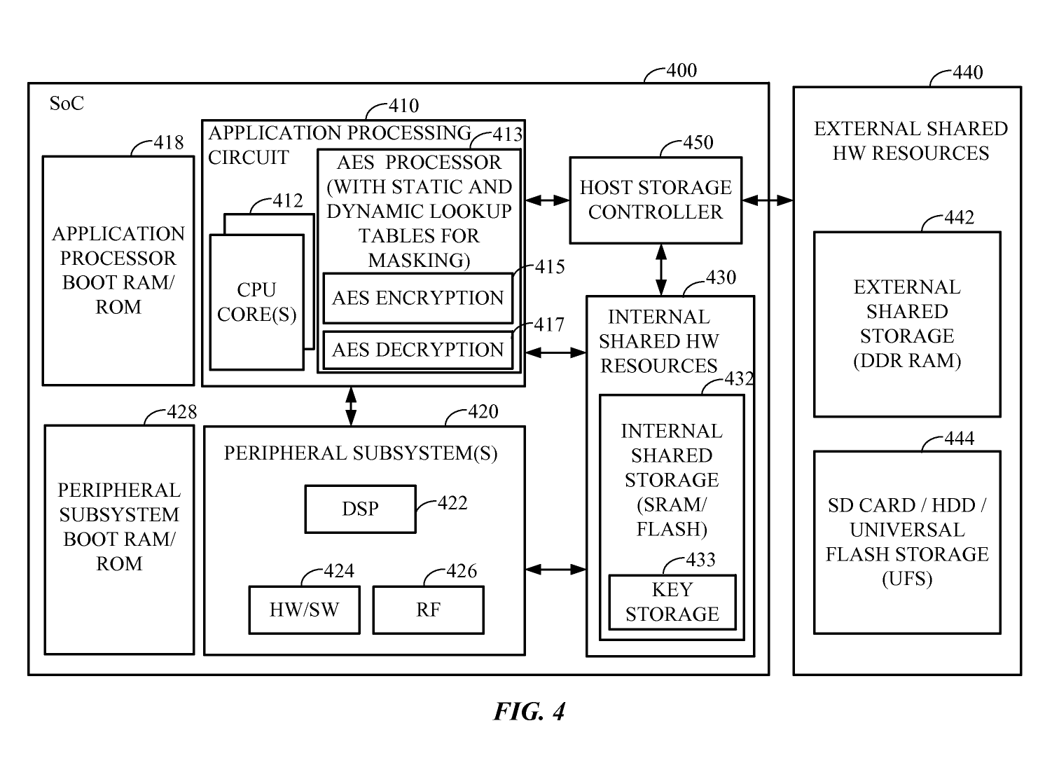

FIG. 4 illustrates a SoC processing circuit 400 of a mobile communication device in accordance with one example where various novel features may be exploited. The SoC processing circuit may be a Snapdragon™ processing circuit of Qualcomm Incorporated. The SoC processing circuit 400 includes an application processing circuit 410, which includes a multi-core CPU 412 equipped to operate in conjunction with an AES processor 413 that employs static and dynamic lookup tables for masking (including a static table that is its own inverse) and includes an AES encryption device 415 and an AES decryption device 417 (which may both include one or more of such static tables as well as one or more dynamic lookup tables).

The application processing circuit 410 typically controls the operation of all components of the mobile communication device. In one aspect, the application processing circuit 410 is coupled to a host storage controller 450 for controlling storage of data, including storage of passkeys in a key storage element 433 of an internal shared storage device 432 that forms part of internal shared hardware (HW) resources 430. The application processing circuit 410 may also include a boot read-only memory (ROM) and/or random access memory (RAM) 418 that stores boot sequence instructions for the various components of the SoC processing circuit 400. The SoC processing circuit 400 further includes one or more peripheral subsystems 420 controlled by application processing circuit 410. The peripheral subsystems 420 may include but are not limited to a storage subsystem (e.g., ROM, RAM), a video/graphics subsystem (e.g., digital signal processing circuit (DSP), graphics processing circuit unit (GPU)), an audio subsystem (e.g., DSP, analog-to-digital converter (ADC), digital-to-analog converter (DAC)), a power management subsystem, security subsystem (e.g., other encryption components and digital rights management (DRM) components), an input/output (I/O) subsystem (e.g., keyboard, touchscreen) and wired and wireless connectivity subsystems (e.g., universal serial bus (USB), Global Positioning System (GPS), Wi-Fi, Global System Mobile (GSM), Code Division Multiple Access (CDMA), 4G Long Term Evolution (LTE) modems). The exemplary peripheral subsystem 420, which is a modem subsystem, includes a DSP 422, various other hardware (HW) and software (SW) components 424, and various radio-frequency (RF) components 426, in one aspect, each peripheral subsystem 420 also includes a boot RAM or ROM 428 that stores a primary boot image (not shown) of the associated peripheral subsystems 420,

As noted, the SoC processing circuit 400 further includes various internal shared HW resources 430, such as an internal shared storage 432 (e.g. static RAM (SRAM), flash memory, etc.), which is shared by the application processing circuit 410 and the various peripheral subsystems 420 to store various runtime data or other parameters and to provide host memory. In the example of FIG. 4, the internal shared storage 432 includes the aforementioned key storage element, portion or component 433 that may be used to store cryptographic keys or passwords. In other examples, keys are stored elsewhere within the mobile device.

In one aspect, the components 410, 418, 420, 428 and 430 of the SoC 400 are integrated on a single-chip substrate. The SoC processing circuit 400 further includes various external shared HW resources 440, which may be located on a different chip substrate and may communicate with the SoC processing circuit 400 via one or more buses. External shared HW resources 440 may include, for example, an external shared storage 442 (e.g. double-data rate (DDR) dynamic RAM) and/or permanent or semi-permanent data storage 444 (e.g., a secure digital (SD) card, hard disk drive (HDD), an embedded multimedia card, a universal flash device (UFS), etc.), which may be shared by the application processing circuit 410 and the various peripheral subsystems 420 to store various types of data, such as an operating system (OS) information, system files, programs, applications, user data, audio/video files, etc. When the mobile communication device incorporating the SoC processing circuit 400 is activated, the SoC processing circuit begins a system boot up process in which the application processing circuit 410 may access boot RAM or ROM 418 to retrieve boot instructions for the SoC processing circuit 400, including boot sequence instructions for the various peripheral subsystems 420. The peripheral subsystems 420 may also have additional peripheral boot RAM or ROM 428.

### Exemplary AES Encryption/Decryption Procedures

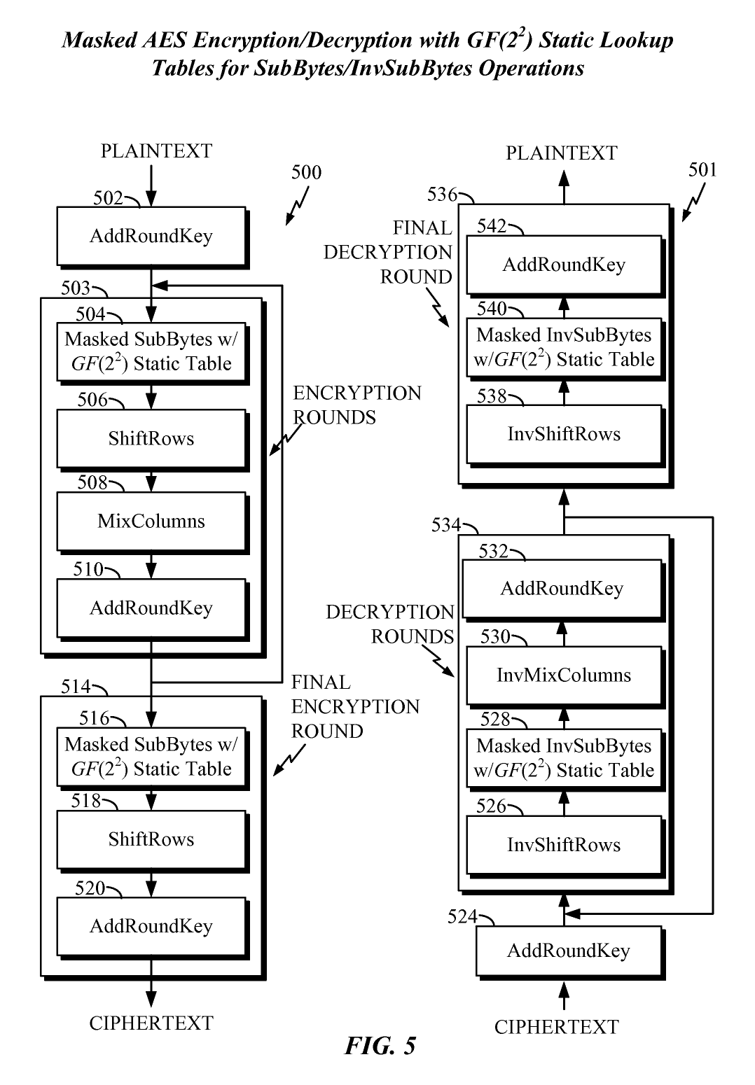

FIG. 5 illustrates exemplary stages for the AES processor 413 of FIG. 4 for use in encryption 500 and decryption 501. The exemplary AES processor 413 employs masked AES encryption/decryption with GF(2²) static lookup tables for SubBytes operations and InvSubBytes operations. For encryption, beginning at 502, an initial AddRoundKey operation is performed on input plaintext, wherein each byte of the current state is combined with a block of a round key. Following the initial AddRoundKey operation, a set of encryption rounds 503 is performed where each round includes a Masked SubBytes stage 504 that exploits one or more GF(2²) static and dynamic lookup tables to facilitate SubBytes operations. For brevity, the Masked SubBytes stage 504 is referred to in the figure as Masked SubBytes w/GE(2²) Static Table but it should be appreciated that the device may include additional components such as one or more dynamic lookup tables. Each encryption round 503 also includes a ShiftRows stage 506, a MixColumns 508 stage and another AddRoundKey stage 510. Following the set of encryption rounds 503, a final encryption round 514 is performed, which includes a final Masked SubBytes stage 516, a final ShiftRows stage 518 and a final AddRoundKey stage 520. As with the Masked SubBytes stage 504, the final Masked SubBytes stage 516 exploits one or more GF(2²) static and dynamic lookup tables to facilitate SubBytes operations. The output is the encrypted ciphertext.

Decryption 501 operates in reverse to convert ciphertext to plaintext. Briefly, beginning at 524, an initial AddRoundKey operation is performed on the input ciphertext, wherein each byte of the current state is combined with a block of a round key. Following the initial AddRoundKey operation, a set of decryption rounds 534 is performed where each round includes an InvShiftRows stage 526, a Masked InvSubBytes substitution stage 528, an InvMixColumns stage 530 and another AddRoundKey stage 532. The Masked InvSubBytes stage 528 is a modified version of a standard masked AES InvSubBytes stage that exploits one or more GF(2²) static and dynamic lookup tables to facilitate InvSubBytes operations. The Masked InvSubBytes stage 528 is referred to in the figure as Masked InvSubBytes w/GF(2²) Static Table but it again should be appreciated that the device may include additional components such as one or more dynamic lookup tables. Following the set of decryption rounds 534, a final decryption round 536 is performed, which includes a final InvShiftRows stage 538, a final Masked InvSubBytes substitution stage 540 and a final AddRoundKey stage 536. As with the Masked InvSubBytes stage 528, the final Masked InvSubBytes stage 538 exploits one or more GF(2²) static and dynamic lookup tables to facilitate Inverse SubBytes operations. The output is the decrypted plaintext.

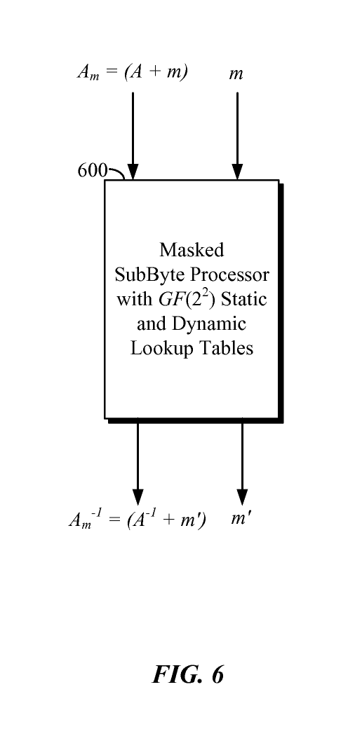

FIG. 6 illustrates an exemplary Masked SubByte substitution processor 600 with a GF(2²) Static and Dynamic Lookup Tables for use as a component of SubBytes devices 504 and 516 of FIG. 5 or for use by other suitable-equipped components, devices, systems or processing circuits. As with the Masked SubByte substitution processor 200 of FIG. 2, the processor 600 of FIG. 6 receives two inputs: Aₘ=(A+m) and m, i.e. a masked value Aₘ and an input mask m where A represents a portion of data to be encrypted (e.g. one byte of a current state thereof). The output is a masked inverse Aₘ⁻¹ and an output mask m′, where the masked inverse may be represented by Aₘ⁻¹=(A⁻¹+m′). Hence, the inputs and outputs of modified substitution processor 600 are the same as that of substitution processor 200 of FIG. 2 and the modified substitution processor of FIG. 6 can be employed wherever substitution processor 200 would otherwise be employed. However, the internal components of the substitution processor 600 of FIG. 6 differ from those of FIG. 2 since substitution processor 600 includes at least one static lookup table in GF(2²) that is its own inverse to facilitate computing the multiplicative inverse, as well as other components such as a dynamic lookup table. That is, the substitution processor 600 of FIG. 6 exploits composite field or tower field computations using GF(2²) where the static and dynamic lookup tables facilitate those GF(2²) computations.

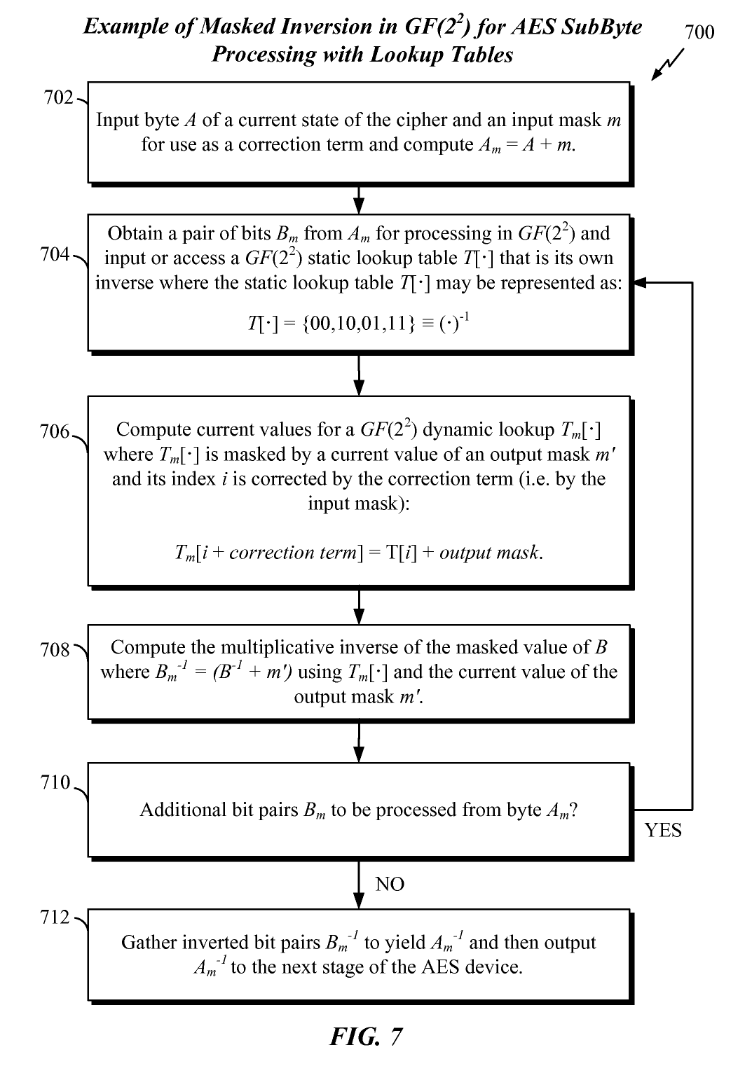

FIG. 7 illustrates an exemplary procedure for use by the Masked SubByte substitution device or processor 600 of FIG. 6 or by other suitable-equipped components, devices, systems or processing circuits, This may be regarded as a “hybrid” procedure as it employs both static and dynamic tables. At 702, the substitution processor inputs byte A of a current state of the cipher and an input mask in for use as a correction term and computes Aₘ=A+m. At 704, the processor obtains a pair of bits Bₘ from Aₘ for processing in GF(2²). As part of this process, the device employs a procedure that brings an element of GF(2⁴) to a pair of elements in GF(2²)×GF(2²). Consider, for example, a string of 4 bits B=(b₁₁, b₁₀, b₀₁, b₀₀) in GF(2⁴). In a normal basis (e.g. the basis discussed, for example, in the Canright papers cited above), a bit split is used to convert from GF(2⁴) to GF(2²). Hence, the mapping is such that B=[b₁, b₀] corresponds to the cascade of the bit pair b₁=(b₁₁, b₁₀)—left or upper part of B, and b₀=(b₀₁, b₀₀,) right or lower part of B. Note that b₁ and b₀ are elements in GF(2²). Also at 704, the substitution processor inputs or accesses a GF(2²) static lookup table T[·] and a current value of an output mask m′ where the static lookup table T[·] may be represented as:

T[·]={00,10,01,11}≡(·)⁻¹ (9)

(or its permutations) and the initial current value for the output mask m′ may be set to the value of the input mask or other suitable default value. At 706, the substitution processor computes current values for a GF(2²) dynamic lookup Tₘ[·] where Tₘ[·] is masked by the current value for the output mask m′ and its index i is corrected by the correction term (i.e. by the input mask):

Tₘ[i+correction term]=T[i]+output mast. (10)

At 708, substitution processor computes the multiplicative inverse of the masked value of B (i.e. Bₘ) where Bₘ⁻¹×(B⁻¹+m′) using Tₘ[·], MT[ ] and MT′[ ] (at least in principle) and the current value of the output mask m′. See above for details of this operation. At 710, if additional bit pairs Bₘ need to be processed from masked input byte Aₘ, processing returns to 704. Once the last of the bit pairs Bₘ is processed, the bit pairs are gathered to yield Aₘ⁻¹, which is then output to the next stage of the AES device. In this regard, the GF(2²) values are subject to computations to generate a left and right part of the outcome, e.g., pₘ=(b₁₁ₘ⁻¹, b₁₀ₘ⁻¹) and qₘ=(b₀₁ₘ⁻¹, b₀₀ₘ⁻¹), which are gathered together to provide an element in GF(2⁴), which is Bₘ⁻¹=(b₁₁ₘ⁻¹, b₁₀ₘ⁻¹, b₀₁ₘ⁻¹, b₀₀ₘ⁻¹). Again, see above for details of this operation.

Note that in the case of inversion in GF(2⁴), Bₘ⁻¹ would be the inverse of the input Bₘ. In the case of a representation different from that of Canright, e.g., when elements of the Galois field are represented in the classic polynomial base, there exist linear mappings from GF(2⁴) to GF(2²) and vice versa, which are more sophisticated than bit split and gather. Hence, aspects of the techniques described herein are independent from the particular representation of the elements in the Galois fields. That is, instead of performing all the complex computations of Equations (4), (5) and (6) above, the device can instead compute (within operations 706 and 708 of FIG. 7):

cₘ⁻¹=Tₘ[cₘ;m] (11)

Bₘ⁻¹=(pₘ, qₘ)=(MT′[cₘ⁻¹; b₀,q₁], MT′[cₘ⁻¹; b₁,q₀]). (12)

In (11) cₘ is indexes Tₘ and m serves to compute the circular permutation. In (12), cₘ⁻¹ indexes MT′, whereas bᵢ and qᵢ serve to compute the circular permutations. The outcome to GF(2⁴) is the two-bit pair Bₘ⁻¹ and its corresponding mask (the input mask to the inversion in GF(2²)), which is q=[q₁, q₀], which are ultimately combined to yield output Aₘ⁻¹. As already explained, the computations using static and dynamic tables are mostly performed in GF(2²) based on the components of Bₘ that are obtained from Aₘ.

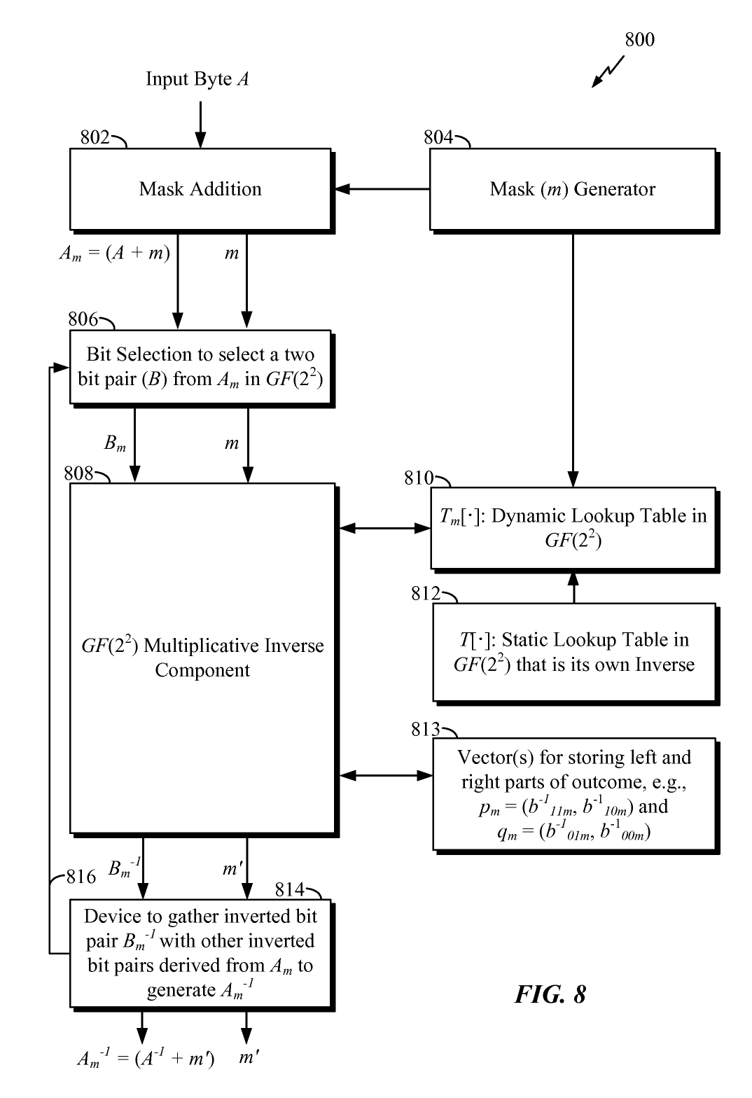

FIG. 8 illustrates exemplary components 800 of the Masked SubByte substitution processor 600 of FIG. 6 that employs a hybrid configuration with both static and dynamic lookup tables. A Mask Addition component 802 adds a mask m generated by a Mask Generator 804 to an input byte A of the current state of the cipher, yielding Aₘ=A+m and m. These values are input to a Bit Selection component 806 that operates to obtain a pair of two-bit in Bₘ from byte Aₘ for inversion in GF(2₂). A GF(2²) Multiplicative Inverse component 808 operates to perform a multiplicative inverse of the pair of two-bits in Bₘ using the techniques already described, by exploiting information in a Dynamic Lookup Table in GF(2²) 810 (i.e. Tₘ[·]) obtained via a Static Lookup Table in GF(2²) 812 (i.e. T[·]). The Dynamic Lookup table 810 has values that are computed “on the fly” as mask values (i.e. correction values) become available from the Mask Generator 804. The Multiplicative Inverse component 808 also uses, in this example, one or more vectors 813 for storing left and right parts of an outcome value (e.g. e.g., pₘ=(b₁₁ₘ⁻¹, b₁₀ₘ⁻¹) and qₘ=(b₀₁ₘ^{-m}, b₀₀ₘ⁻¹), discussed above).

The output of the Multiplicative Inverse component 808 includes inverted two two-bit in Bₘ⁻¹ and corresponding output mask m′. The inverted bit pair Bₘ⁻¹ is then gathered together with other hit pairs using device 814 that gathers (or otherwise merges or combines) the inverted bit pair Bₘ⁻¹ with other inverted bit pairs derived from Aₘ to yield the inverted masked byte Aₘ⁻¹=(A⁻¹+m′). See above for descriptions of this operation. In one implementation, as shown by arrow 816, the operations of components 806, 808 and 814 are performed in a loop to process all of the bit pairs of masked byte Aₘ. In other implementations, however, a set of GF(2²) Multiplicative Inverse components 808 are provided to operate in parallel so that all of the bits of masked byte Aₘ can be inverted concurrently so as to reduce processing time. Note that, although not shown, the processor 800 of FIG. 8 may include components for removing the mask from Aₘ⁻¹ to yield a final output of A⁻¹for processing by the next stage of the AES encryption device.

For decryption, similar components are provided to perform Masked InvSubBytes operations instead of Masked SubBytes. Moreover, although described with respect to AES examples where the subfield is GF(2²), aspects of the systems and methods described herein are applicable to ciphers other than AES and to finite subfields other than GF(2²).

In accordance with aspects of the disclosure presented herein, implementations may be provided that exploit one or more of the following:
a. Implementations can employ fully static tables—e.g., by statically storing all needed permutations,
b. Implementations can employ dynamic tables, with both correction terms and operations occurring in the form of permutations. Tₘ in this case may be a permutation of T.
c. Implementations can employ both static and dynamic tables (i.e. the hybrid configuration primarily described hereinabove) where some tables are statically stored, e.g., {0, 1, 2, 3} and the unmasked inverse {0, 2, 1, 3 }, the masked version of the table is derived with bitwise XOR operations and the masked operation is carried out by first permuting and indexing the masked version of the table. As explained, this process can be similar for both the computation of the masked inverse and the masked multiplications in GF(2²), though the specific permutations are different,

The hybrid version (i.e. implementation “c”) was described in detail above. The fully static version (i.e. implementation “a”) may be implemented in a generally similar manner while taking into account the following during inversion:

Input: cₘ=c+m; Output: cₘ⁻¹=c⁻¹+m

In this regard, because m ∈ {0, 1, 2, 3}, the device can statically store precomputed values of the possible outcomes of T[ ]+m, where T[ ]={0, 2, 3, }. This corresponds to storing the following 4 bytes matrix for the masked inversion, as illustrated below. The first row is T[ ]+m, when m=0, the second row is T[ ]+m, when m=1, the third row is T[ ]+m, when m=2 and the fourth row is T[ ]+m, when m=3.

$$\begin{matrix}\{ 0 , 2 , 1 , 3 , \\ 2 , 1 , 3 , 0 \\ 3 , 1 , 2 , 0 \\ 1 , 2 , 0 , 3 \}\end{matrix}$$

To compute the masked inverse, i.e., the output cₘ⁻¹=c⁻¹+m, the correction term indexes one row of the matrix above (e.g., if m=0, the correction term indexes the row zero), and uses the masked input, i.e., the input cₘ=c+m, to index the column. The same principle is applied to the masked multiplications, thought the number of permutations to store is larger.

The fully dynamic version (i.e. implementation “b”) may be implemented in a generally similar manner while taking into account the following during inversion (where the input and output are the same as just shown):

input: cₘ=c+m; Output: cₘ⁻¹+m

The fully dynamic inversion starts from a single byte, which contains the elements of the field, e.g., {0, 1, 2, 3} and temporary storage to allow the permutations and elements in the field and to perform the desired masked operation. For example, in the case of the masked inversion, first the elements 1 and 2 are swapped, then permuted by the value of the correction term. The result of this sequence of permutation can be indexed with the input cₘ=c+m to produce the desired output cₘ⁻¹=c⁻¹+m.

For example, assuming cₘ⁻¹=2+1=3, the device may be configured to compute the masked inverse—cₘ⁻¹=1+1=0—in the arithmetic of the field. The permutations are performed that correspond to the selection and shift permutation as illustrated in the previous case. The results of these permutations are the following instances of the elements of the field (i.e., {0, 1, 2, 3}): {3,2,1,0}. More specifically, the permutations of {1, 2, 3} operate to swap the inner two values (e.g. 1 and 2) and then to swap the first and last values (e.g. 0 and 3) to yield {3,2,1,0}. The outcome of indexing the table above with the masked input cₘ=3 is cₘ⁻¹=0, as expected. When the inversion is complete, the dynamic table is restored to its initial value (i.e., {0, 1, 2, 3}) to accommodate the next encryption/decryption request. Similarly, other types of permutations can be implemented for the multiplications.

### Exemplary Systems and Methods

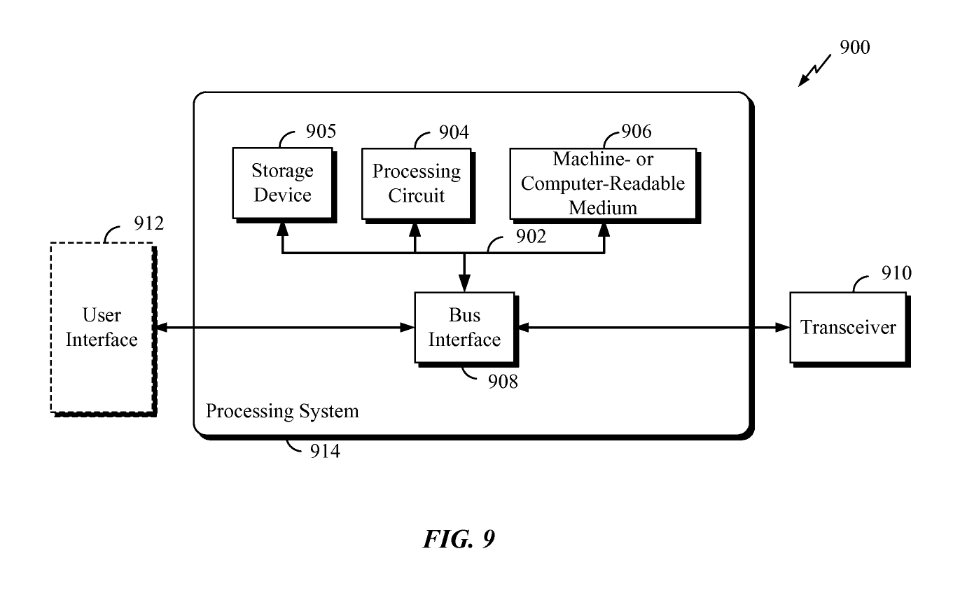

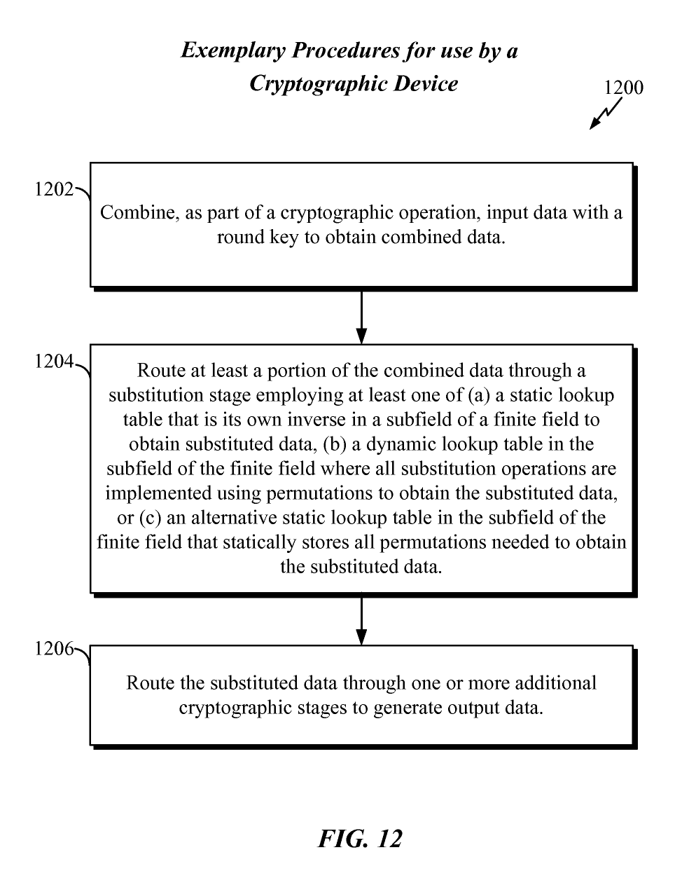

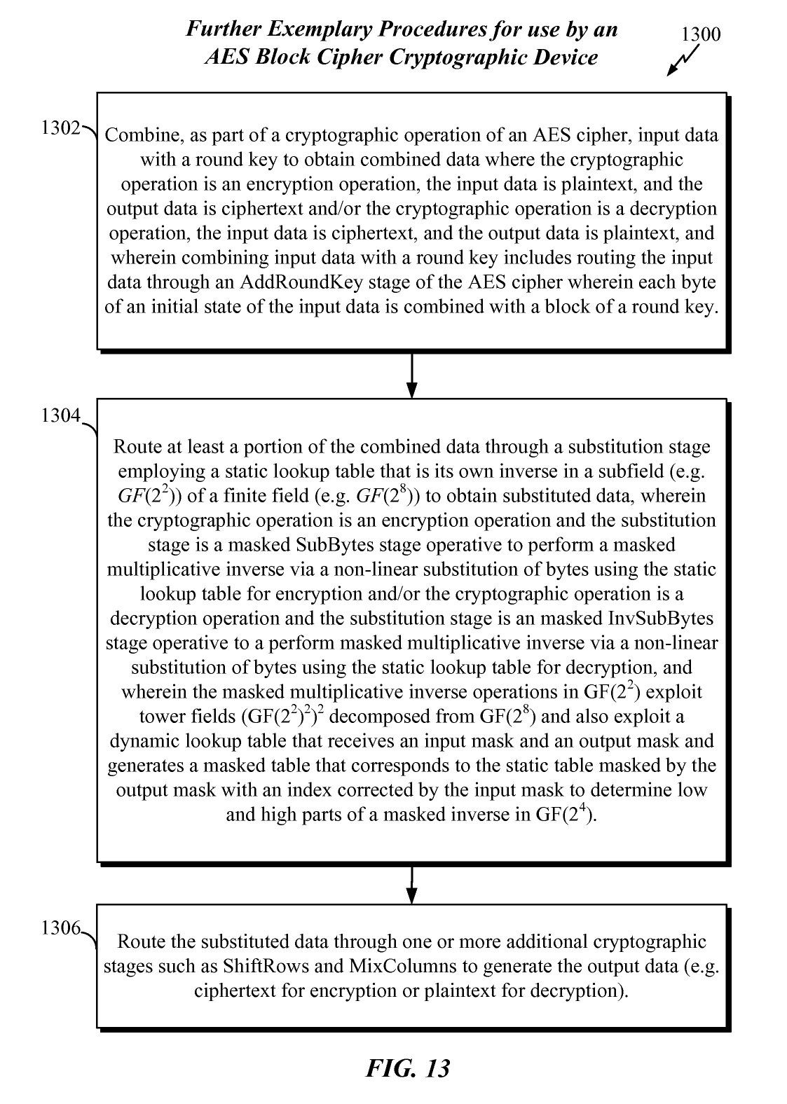

FIG. 9 illustrates an overall system or apparatus 900 in which the systems, methods and apparatus of FIGS. 3-8 may be implemented. In accordance with various aspects of the disclosure, an element, or any portion of an element, or any combination of elements may be implemented with a processing system 914 that includes one or more processing circuits 904 such as the SoC processing circuit of FIG. 2. For example, apparatus 900 may be a user equipment (UE) of a mobile communication system. Apparatus 900 may be used with a radio network controller (RNC), In addition to an SoC, examples of processing circuits 904 include microprocessing circuits, microcontrollers, digital signal processing circuits (DSPs), field programmable gate arrays (FPGAs), programmable logic devices (PLDs), state machines, gated logic, discrete hardware circuits, and other suitable hardware configured to perform the various functionality described throughout this disclosure. Still further, the processing system 914 could be a component of a server such as the server shown in FIG. 1. That is, the processing circuit 904, as utilized in the apparatus 900, may be used to implement any one or more of the processes described above and illustrated in FIGS. 3, 4, 7 and 8 (and those illustrated in FIGS. 12 and 13, discussed below), such as processes to encryption and decryption.

In the example of FIG. 9, the processing system 914 may be implemented with a bus architecture, represented generally by the bus 902. The bus 902 may include any number of interconnecting buses and bridges depending on the specific application of the processing system 914 and the overall design constraints. The bus 902 links various circuits including one or more processing circuits (represented generally by the processing circuit 904), the storage device 905, and a machine-readable, processor-readable, processing circuit-readable or computer-readable media (represented generally by a non-transitory machine-readable medium 906). The bus 902 may also link various other circuits such as timing sources, peripherals, voltage regulators, and power management circuits, which are well known in the art, and therefore, will not be described any further. The bus interface 908 provides an interface between bus 902 and a transceiver 910. The transceiver 910 provides a means for communicating with various other apparatus over a transmission medium. Depending upon the nature of the apparatus, a user interface 912 (e.g., keypad, display, speaker, microphone, joystick) may also be provided.

The processing circuit 904 is responsible for managing the bus 902 and for general processing, including the execution of software stored on the machine-readable medium 906. The software, when executed by processing circuit 904, causes processing system 914 to perform the various functions described herein for any particular apparatus. Machine-readable medium 906 may also be used for storing data that is manipulated by processing circuit 904 when executing software.

One or more processing circuits 904 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

The software may reside on machine-readable medium 906. The machine-readable medium 906 may be a non-transitory machine-readable medium. A non-transitory processing circuit-readable, machine-readable or computer-readable medium includes, by way of example, a magnetic storage device (e.g., hard disk, floppy disk, magnetic strip), an optical disk (e,a., a compact disc (CD) or a digital versatile disc (DVD)), a smart card, a flash memory device (e.g., a card, a stick, or a key drive), RAM, ROM, a programmable ROM (PROM), an erasable PROM (EPROM), an electrically erasable PROM (EEPROM), a register, a removable disk, a hard disk, a CD-ROM and any other suitable medium for storing software and/or instructions that may be accessed and read by a machine or computer. The terms “machine-readable medium”, “computer-readable medium”, “processing circuit-readable medium” and/or “processor-readable medium” may include, but are not limited to, non-transitory media such as portable or fixed storage devices, optical storage devices, and various other media capable of storing, containing or carrying instruction(s) and/or data. Thus, the various methods described herein may be fully or partially implemented by instructions and/or data that may be stored in a “machine-readable medium,” “computer-readable medium,” “processing circuit-readable medium” and/or “processor-readable medium” and executed by one or more processing circuits, machines and/or devices. The machine-readable medium may also include, by way of example, a carrier wave, a transmission line, and any other suitable medium for transmitting software and/or instructions that may be accessed and read by a computer.

The machine-readable medium 906 may reside in the processing system 914, external to the processing system 914, or distributed across multiple entities including the processing system 914. The machine-readable medium 906 may be embodied in a computer program product. By way of example, a computer program product may include a machine-readable medium in packaging materials. Those skilled in the art will recognize how best to implement the described functionality presented throughout this disclosure depending on the particular application and the overall design constraints imposed on the overall system. For example, the machine-readable storage medium 906 may have one or more instructions which when executed by the processing circuit 904 causes the processing circuit to: combine, as part of a cryptographic operation, input data with a round key to obtain combined data route at least a portion of the combined data through a substitution stage employing a static lookup table that is its own inverse in a subfield of the finite field to obtain substituted data and route the substituted data through one or more additional cryptographic stages to generate an output data.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

The various illustrative logical blocks, modules, circuits, elements, and/or components described in connection with the examples disclosed herein may be implemented or performed with a general purpose processing circuit, a digital signal processing circuit (DSP), an application specific integrated circuit (ASIC), a field programmable gate array (FPGA) or other programmable logic component, discrete gate or transistor logic, discrete hardware components, or any combination thereof designed to perform the functions described herein. A general purpose processing circuit may be a microprocessing circuit, but in the alternative, the processing circuit may be any conventional processing circuit, controller, microcontroller, or state machine. A processing circuit may also be implemented as a combination of computing components, e.g., a combination of a DSP and a microprocessing circuit, a number of microprocessing circuits, one or more microprocessing circuits in conjunction with a DSP core, or any other such configuration.

Hence, in one aspect of the disclosure, processing circuit 413 illustrated in FIG. 4 may be a specialized processing circuit (e.g., an ASIC)) that is specifically designed and/or hard-wired to perform at least some of the algorithms, methods, and/or blocks described in FIGS. 3, 4, 7 and 8 (and those illustrated in FIGS. 12 and 13. discussed below) such as those directed to encrypting and decrypting messages. Thus, such a specialized processing circuit (e.g., ASIC) may be one example of a means for executing the algorithms, methods, and/or blocks described in FIGS. 3, 4, 7 and 8 (and those illustrated in FIGS. 12 and 13, discussed below). The machine-readable storage medium may store instructions that when executed by a specialized processing circuit (e.g., ASIC) causes the specialized processing circuit to perform the algorithms, methods, and/or blocks described herein. In another aspect of the disclosure, the remote server system 108 of FIG. 1 may also include a specialized processing circuit specifically designed and/or hard-wired to perform at least some of the algorithms, methods, and/or blocks described in FIGS. 3, 4, 7 and 8 (and those illustrated in FIGS. 12 and 13, discussed below) such as those directed to encrypting and decrypting messages. Thus, such a specialized processing circuit may be one example of a means for executing the algorithms, methods, and/or blocks described in FIGS. 3, 4, 7 and 8 (and those illustrated in FIGS. 12 and 13, discussed below). The machine-readable storage medium may store instructions that when executed by a specialized processing circuit (e.g., ASIC) causes the specialized processing circuit to perform the algorithms, methods, and/or blocks described herein.

In at least some examples, a cryptographic device is provided that includes; means for combining, as part of a cryptographic operation, input data with a round key to obtain combined data; means for routing at least a portion of the combined data through a substitution stage employing a static lookup table that is its own inverse in a subfield of the finite field to obtain substituted data; and means for routing the substituted data through one or more additional cryptographic stages to generate an output data.

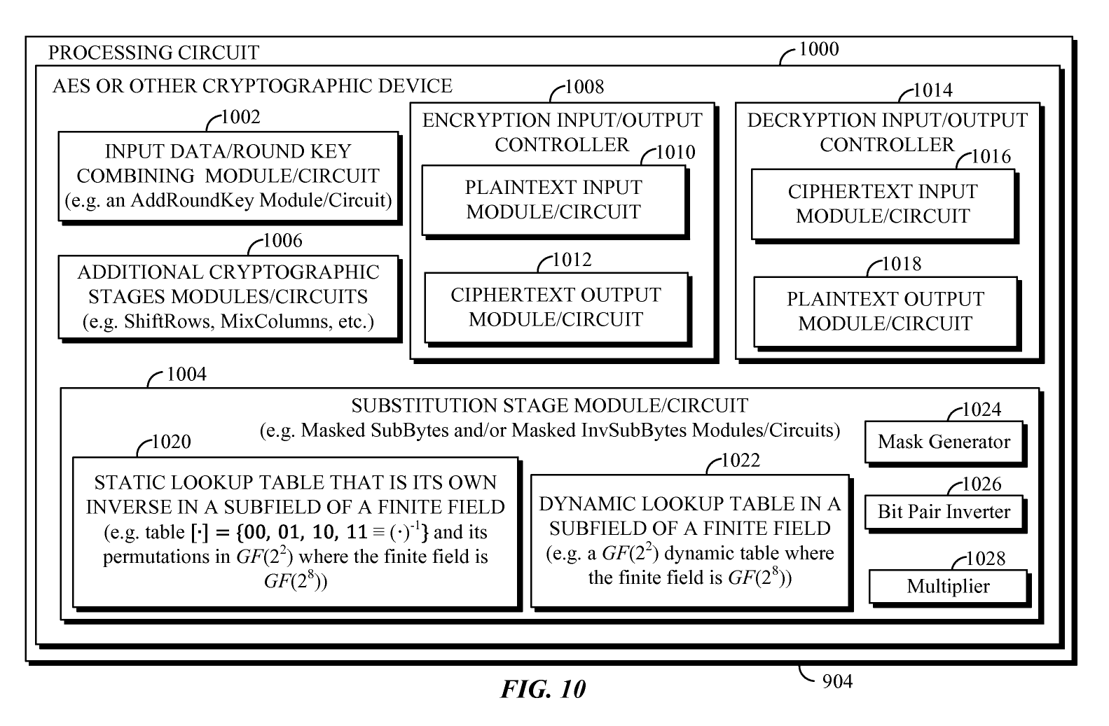

FIG. 10 illustrates selected and exemplary components of processing circuit 904 of, e.g., a mobile device or smartcard that includes an AES or other cryptographic device 1000 for use with a hybrid implementation that employs both static and dynamic tables. The cryptographic device 1000 includes an input data/round key combining module/circuit 1002 (e.g. an AddRoundKey Module/Circuit) that is operative to combine, as part of a cryptographic operation, input data (such as plaintext for encryption or ciphertext for decryption) with a round key to obtain combined data. The cryptographic device 1000 also includes: a substitution stage module/circuit 1004 (e.g. Masked SubBytes and/or Masked lnvSubBytes Modules/Circuits) employing a static lookup table that is its own inverse in a subfield of the finite field to obtain substituted data; and one or more additional cryptographic stages modules/circuits 1006 (e.g. ShiftRows, MixColumns, etc.) operative to process the substituted data through one or more additional cryptographic stages to generate an output data. An encryption input/output controller 1008 is operative to control the input and output of data for encryption and includes a plaintext input module/circuit 1010 operative to input plaintext to be encrypted and a ciphertext output module/circuit 1012 operative to output ciphertext. A decryption input/output controller 1014 is operative to control the input and output of data for decryption and includes a ciphertext input module/circuit 1016 operative to input ciphertext to be decrypted and a plaintext output module/circuit 1018 operative to output plaintext. In this example, the substitution stage module/circuit 1004 includes a static lookup table 1020 that is its own inverse in a subfield of a finite field (e.g.[·]={00, 01, 10, 11} and its permutations in GF(2²) where the finite field is GF(2⁸). The substitution stage module/circuit 1022 also includes a dynamic lookup table 1022 in the subfield of the finite field (e.g. a GF(2²) dynamic table where the finite field is GF(2⁸)). As already explained, these tables facilitate masked multiplicative inversion operations, which may be performed under the control of a mask generator 1024, a hit pair inverter 1026 and a multiplier 1028, each of which operates in GF(2²) or some other suitable subfield of a finite field.

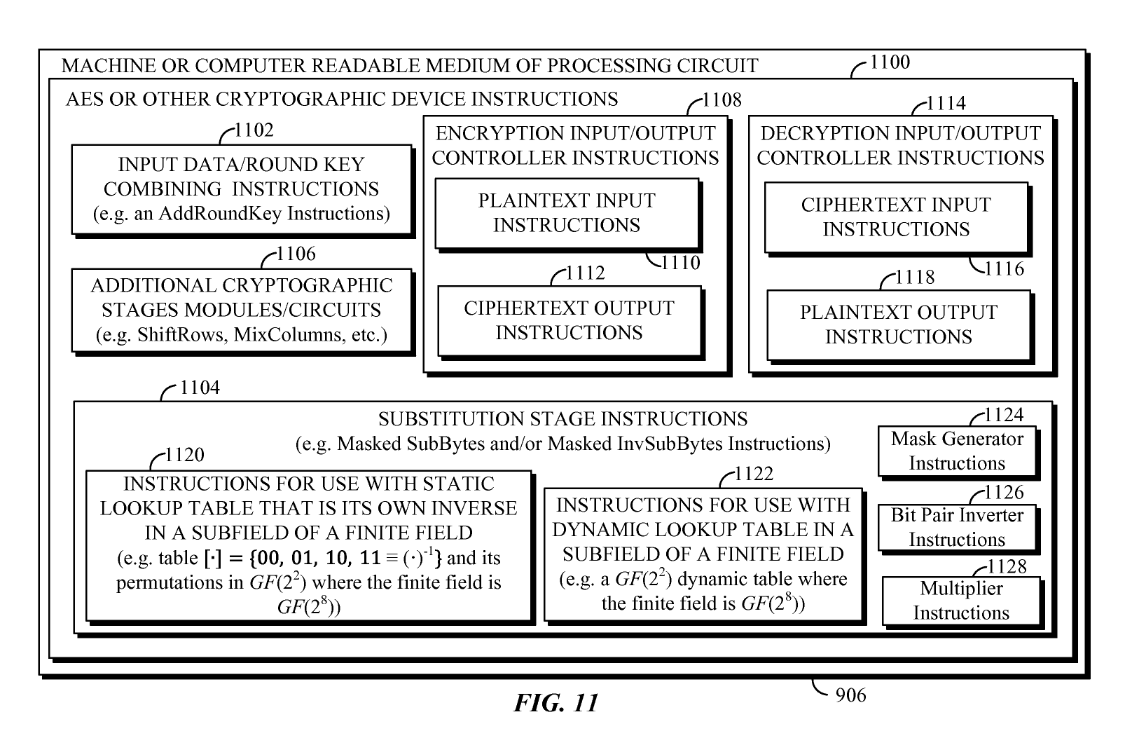

FIG. 11 illustrates selected and exemplary instructions of machine- or computer-readable medium 906 for use in encryption and decryption for use with the hybrid implementation that employs both static and dynamic tables. A set of AES or other cryptographic device processing instructions 1100 are provided which when executed by the processing circuit 904 of FIG. 9 cause the processing circuit to control or perform encryption and decryption operations. The cryptographic device processing instructions 1100 include input data/round key combining instructions 1102 (e.g. AddRoundKey instructions) that are operative to combine, as part of a cryptographic operation, input data (such as plaintext for encryption or ciphertext for decryption) with a round key to obtain combined data. The cryptographic instructions 1100 also include: substitution stage instructions 1104 (e.g. Masked SubBytes and/or Masked InvSubBytes instructions) employing a static lookup table that is its own inverse in a subfield of the finite field to obtain substituted data; and one or more additional cryptographic stages instruction 1106 (e.g. ShiftRows instructions, MixColumns instructions, etc.) operative to process the substituted data through one or more additional cryptographic stages to generate output data. Encryption input/output controller instructions 1108 are operative to control the input and output of data for encryption and include plaintext input instructions 1110 operative to input plaintext to be encrypted and ciphertext output instructions 1112 operative to output ciphertext. Decryption input/output controller instructions 1114 are operative to control the input and output of data for decryption and include ciphertext input instructions 1116 operative to input ciphertext to be decrypted and plaintext output instructions 1118 operative to output plaintext. In this example, the substitution stage instructions 1104 may include instructions for use with a static lookup table 1120 that is its own inverse in a subfield of a finite field (e.g. [·]={00, 01, 10, 11} and its permutations in GF(2²) where the finite field is GF(2⁸). The substitution stage instructions 1122 may also include instructions for use with a dynamic lookup table 1122 in the subfield of the finite field (e.g. a GF(2²) dynamic table Where the finite field is GF(2⁸)). As already explained, these tables facilitate masked multiplicative inversion operations, which may be performed under the control of mask generator instructions 1124, bit pair inverter instructions 1126 and multiplier instructions 1128, each of which operates in GF(2²) or some other suitable subfield of a finite field.

FIG. 12 broadly illustrates and summarizes methods or procedures 1200 that may be performed by a cryptographic device of the processing circuit 904 of FIG. 9 or other suitably equipped cryptographic devices for encryption and/or decryption. At 1202, the cryptographic device combines, as part of a cryptographic operation, input data with a round key to obtain combined data. The combined data may be, for example, a portion of plaintext, a portion of masked plaintext, a value that is a function of plaintext, a value that is a function of masked plaintext, a portion of ciphertext, a portion of masked ciphertext, a value that is a function of ciphertext and/or a value that is a function of masked ciphertext. At 1204, the cryptographic device routes at least a portion of the combined data through a substitution stage employing at least one of (a) a static lookup table that is its own inverse in a subfield of the finite field to obtain substituted data, (b) a dynamic lookup table in the subfield of the finite field where all substitution operations are implemented using permutations to obtain the substituted data, or (c) an alternative static lookup table in the subfield of the finite field that statically stores all permutations needed to obtain the substituted data. At 1206, the cryptographic device routes the substituted data through one or more additional cryptographic stages to generate an output data.

FIG. 13 illustrates and summarizes further methods or procedures 1300 that may be performed by a cryptographic device of the processing circuit 904 of FIG. 9 or other suitably equipped cryptographic devices for encryption and/or decryption. At 1302, the cryptographic device combines, as part of a cryptographic operation of an AES cipher, input data with a round key to obtain combined data where the cryptographic operation is an encryption operation, the input data is plaintext, and the output data is ciphertext and/or the cryptographic operation is a decryption operation, the input data is ciphertext, and the output data is plaintext, and wherein combining input data with a round key includes routing the input data through an AddRoundKey stage of the AES cipher wherein each byte of an initial state of the input data is combined with a block of a round key. At 1304, the cryptographic device routes at least a portion of the combined data through a substitution stage employing a static lookup table that is its own inverse in a subfield (e.g. GF(2²)) of a finite field (e.g. GF(2⁸)) to obtain substituted data, wherein the cryptographic operation is an encryption operation and the substitution stage is a masked SubBytes stage operative to perform a masked multiplicative inverse via a non-linear substitution of bytes using the static lookup table for encryption and/or the cryptographic operation is a decryption operation and the substitution stage is an masked InvSubBytes stage operative to a perform masked multiplicative inverse via a non-linear substitution of bytes using the static lookup table for decryption, and wherein the masked multiplicative inverse operations in GF(2²) exploit tower fields (GF(2²)²)² decomposed from GF(2⁸) and also exploit a dynamic lookup table that receives an input mask and an output mask and generates a masked table that corresponds to the static table masked by the output mask with an index corrected by the input mask to determine low and high parts of a masked inverse in GF(2⁴). At 1306, the cryptographic device routes the substituted data through one or more additional cryptographic stages such as ShiftRows and MixColumns to generate the output data (e.g, ciphertext for encryption or plaintext for decryption).

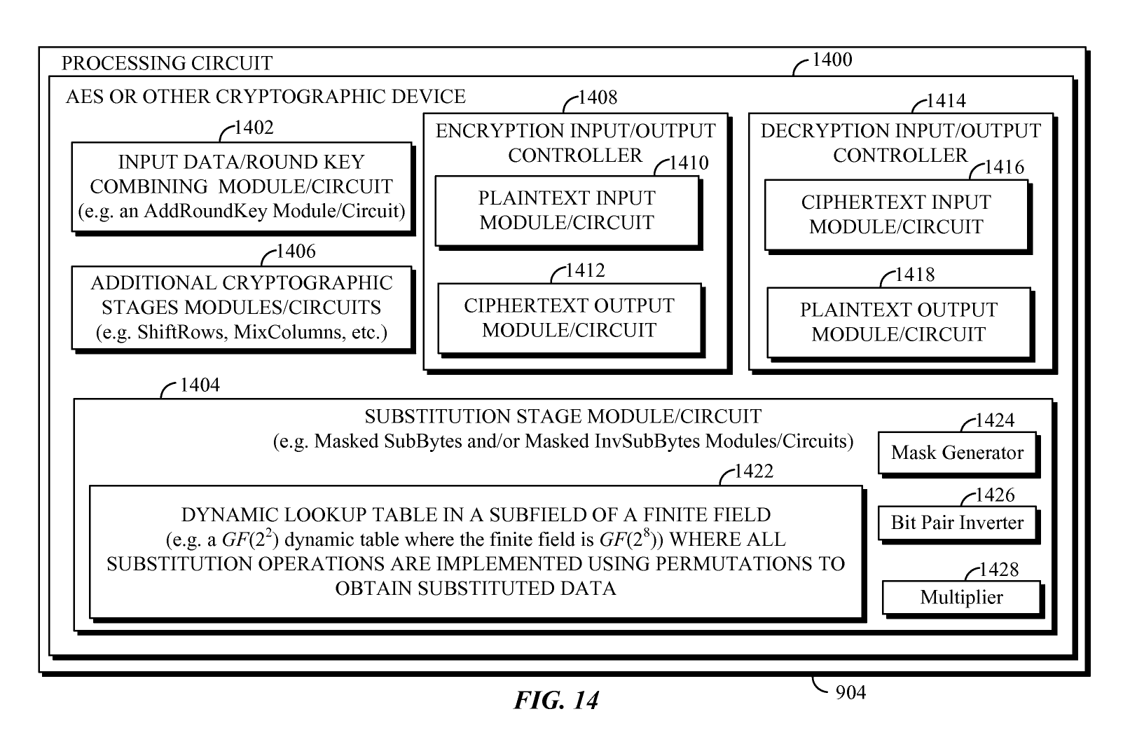

FIG. 14 illustrates selected and exemplary components of processing circuit 904 of e.g., a mobile device or smartcard that includes an AES or other cryptographic device 1400 for use with a dynamic table implementation wherein the substitution operations are implemented using permutations to obtain substituted data. The cryptographic device 1400 includes an input data; round key combining module/circuit 1402 (e.g. an AddRoundKey Module/Circuit) that is operative to combine, as part of a cryptographic operation, input data (such as plaintext for encryption or ciphertext for decryption) with a round key to obtain combined data. The cryptographic device 1400 also includes: a substitution stage module/circuit 1404 (e.g. Masked SubBytes and/or Masked InvSubBytes Modules/Circuits) employing a static lookup table that is its own inverse in a subfield of the finite field to obtain substituted data; and one or more additional cryptographic stages modules/circuits 1406 (e.g. ShiftRows, MixColumns, etc.) operative to process the substituted data through one or more additional cryptographic stages to generate an output data. An encryption input/output controller 1408 is operative to control the input and output of data for encryption and includes a plaintext input module/circuit 1410 operative to input plaintext to be encrypted and a ciphertext output module/circuit 1412 operative to output ciphertext. A decryption input/output controller 1414 is operative to control the input and output of data for decryption and includes a ciphertext input module/circuit 1416 operative to input ciphertext to be decrypted and a plaintext output module/circuit 1418 operative to output plaintext. In this example, the substitution stage module/circuit 1404 includes no static lookup table. Rather, the substitution stage module/circuit 1404 includes a dynamic lookup table 1422 in a subfield of the finite field where all substitution operations are implemented using permutations to obtain substituted data. As already explained, the dynamic table facilitates masked multiplicative inversion operations, which may be performed under the control of a mask generator 1424, a bit pair inverter 1426 and a multiplier 1428, each of which operates in GF(2²) or some other suitable subfield of a finite field.

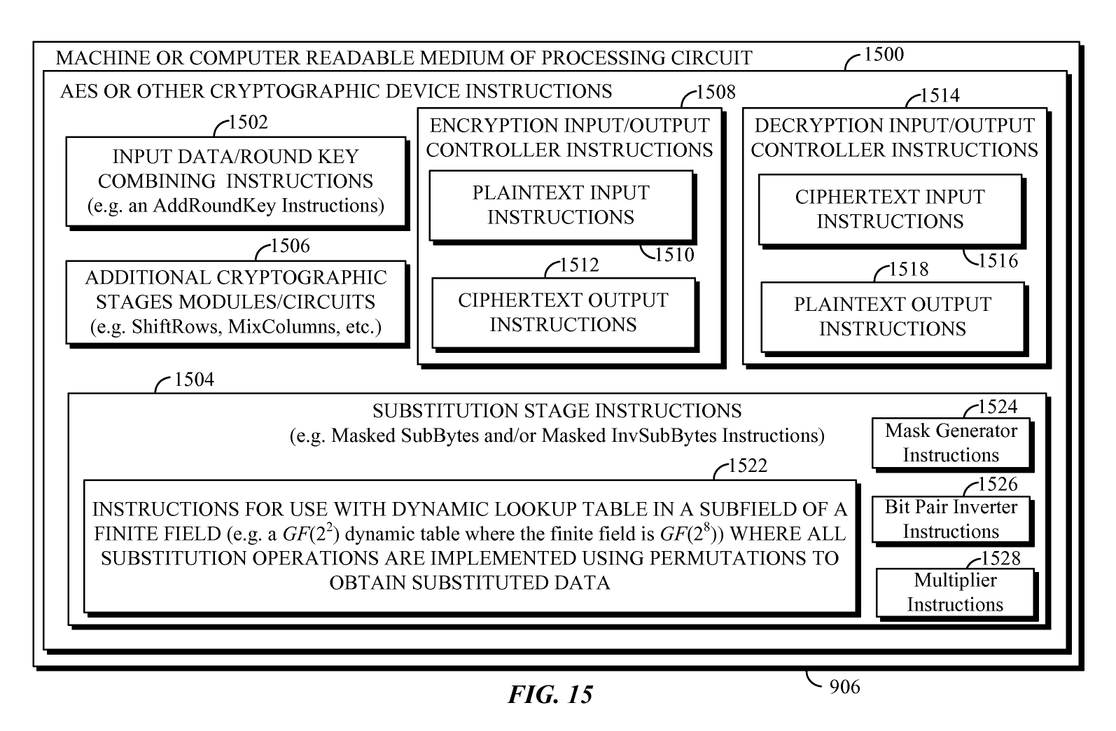

FIG. 15 illustrates selected and exemplary instructions of machine- or computer-readable medium 906 for use in encryption and decryption for use with a dynamic table implementation wherein the substitution operations are implemented using permutations to obtain substituted data. A set of AES or other cryptographic device processing instructions 1500 are provided which when executed by the processing circuit 904 of FIG. 9 cause the processing circuit to control or perform encryption and decryption operations. The cryptographic device processing instructions 1500 include input data/round key combining instructions 1502 (e.g. AddRoundKey instructions) that are operative to combine, as part of a cryptographic operation, input data (such as plaintext for encryption or ciphertext for decryption) with a round key to obtain combined data. The cryptographic instructions 1500 also include: substitution stage instructions 1504 (e.g. Masked SubBytes and/or Masked InvSubBytes instructions) employing a static lookup table that is its own inverse in a subfield of the finite field to obtain substituted data; and one or more additional cryptographic stages instruction 1506 (e.g. ShiftRows instructions, MixColumns instructions, etc.) operative to process the substituted data through one or more additional cryptographic stages to generate output data. Encryption input/output controller instructions 1508 are operative to control the input and output of data for encryption and include plaintext input instructions 1510 operative to input plaintext to be encrypted and ciphertext output instructions 1512 operative to output ciphertext. Decryption input/output controller instructions 1514 are operative to control the input and output of data for decryption and include ciphertext input instructions 1516 operative to input ciphertext to be decrypted and plaintext output instructions 1518 operative to output plaintext. As with FIG. 14, the substitution stage module/circuit 1504 includes no static lookup table. Rather, the substitution stage instructions 1522 include instructions for use with a dynamic lookup table 1522 in a subfield of the finite field where all substitution operations are implemented using permutations to obtain substituted data. As already explained, the dynamic table facilitates masked multiplicative inversion operations, which may be performed under the control of mask generator instructions 1524, bit pair inverter instructions 1526 and multiplier instructions 1528, each of which operates in GF(2²) or some other suitable subfield of a finite field.

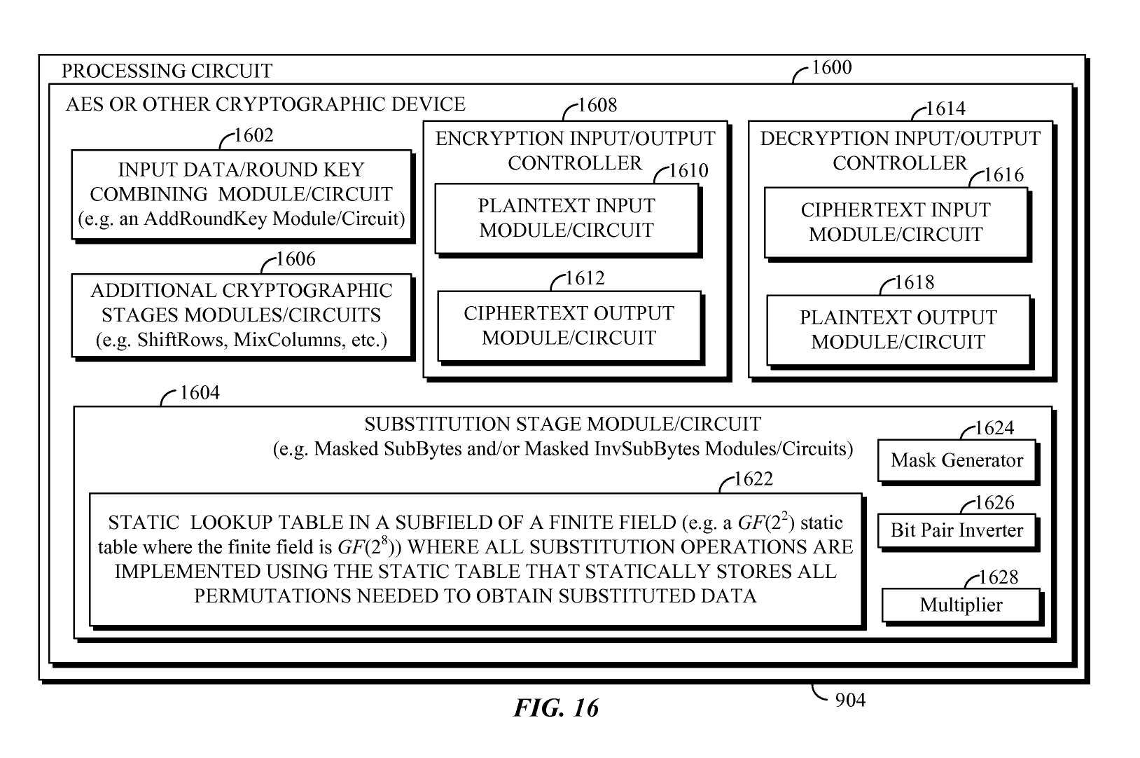

FIG. 16 illustrates selected and exemplary components of processing circuit 904 of, e.g., a mobile device or smartcard that includes an AES or other cryptographic device 1600 for use with a static table implementation wherein all substitution operations are implemented using the static table that statically stores all permutations needed to obtain substituted data. The cryptographic device 1600 includes an input data/round key combining module/circuit 1602 (e.g. an AddRoundKey Module/Circuit) that is operative to combine, as part of a cryptographic operation, input data (such as plaintext for encryption or ciphertext for decryption) with a round key to obtain combined data. The cryptographic device 1600 also includes: a substitution stage module/circuit 1604 (e.g. Masked SubBytes and/or Masked InvSubBytes Modules/Circuits) employing a static lookup table that is its own inverse in a subfield of the finite field to obtain substituted data and one or more additional cryptographic stages modules/circuits 1606 (e.g. ShiftRows, MixColumns, etc.) operative to process the substituted data through one or more additional cryptographic stages to generate an output data. An encryption input/output controller 1608 is operative to control the input and output of data for encryption and includes a plaintext input module/circuit 1610 operative to input plaintext to be encrypted and a ciphertext output module/circuit 1612 operative to output ciphertext. A decryption input/output controller 1614 is operative to control the input and output of data for decryption and includes a ciphertext input module/circuit 1616 operative to input ciphertext to be decrypted and a plaintext output module/circuit 1618 operative to output plaintext. In this example, the substitution stage module/circuit 1604 includes no dynamic lookup table. Rather, the substitution stage module/circuit 1604 includes a static lookup table 1622 in a subfield of the finite field where all substitution operations are implemented using the static table that statically stores all permutations needed to obtain substituted data. As already explained, the static table facilitates masked multiplicative inversion operations, which may be performed under the control of a mask generator 1624, a bit pair inverter 1626 and a multiplier 1628, each of which operates in GF(2²) or some other suitable subfield of a finite field.

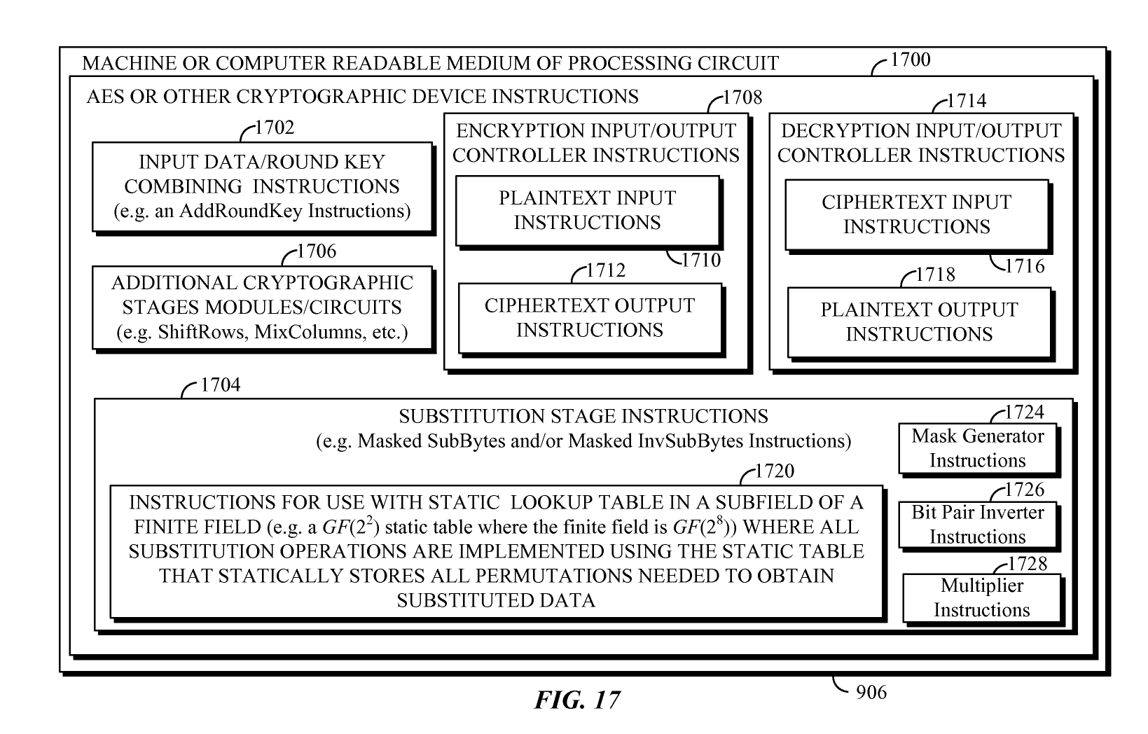

FIG. 17 illustrates selected and exemplary instructions of machine- or computer-readable medium 906 for use in encryption and decryption for use with the static table implementation wherein all substitution operations are implemented using the static table that statically stores all permutations needed to obtain substituted data. A set of AES or other cryptographic device processing instructions 1700 are provided which when executed by the processing circuit 904 of FIG. 9 cause the processing circuit to control or perform encryption and decryption operations. The cryptographic device processing instructions 1700 include input data/round key combining instructions 1702 (e.g. AddRoundKey instructions) that are operative to combine, as part of a cryptographic operation, input data (such as plaintext for encryption or ciphertext for decryption) with a round key to obtain combined data. The cryptographic instructions 1700 also include: substitution stage instructions 1704 (e.g. Masked SubBytes and/or Masked InvSubBytes instructions) employing a static lookup table that is its own inverse in a subfield of the finite field to obtain substituted data and one or more additional cryptographic stages instruction 1706 (e.g. ShiftRows instructions, MixColumns instructions, etc.) operative to process the substituted data through one or more additional cryptographic stages to generate output data. Encryption input/output controller instructions 1708 are operative to control the input and output of data for encryption and include plaintext input instructions 1710 operative to input plaintext to be encrypted and ciphertext output instructions 1712 operative to output ciphertext. Decryption input/output controller instructions 1714 are operative to control the input and output of data for decryption and include ciphertext input instructions 1716 operative to input ciphertext to be decrypted and plaintext output instructions 1718 operative to output plaintext. In this example, the substitution stage module/circuit 1704 includes no dynamic lookup table. Rather, the substitution stage instructions 1704 include instructions for use with a static lookup table 1720 in a subfield of the finite field where all substitution operations are implemented using the static table that statically stores all permutations needed to obtain substituted data. As already explained, this static table facilitates masked multiplicative inversion operations, which may be performed under the control of mask generator instructions 1724, bit pair inverter instructions 1726 and multiplier instructions 1728, each of which operates in GF(2²) or some other suitable subfield of a finite field.

Note that aspects of the present disclosure may be described herein as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method operational in a cryptographic device, comprising:
combining, as part of a cryptographic operation, input data with a round key to obtain combined data;
routing at least a portion of the combined data through a substitution stage employing at least one of
a static lookup table that is its own inverse in a subfield of a finite field to obtain substituted data,
a dynamic lookup table in the subfield of the finite field where all substitution operations are implemented using permutations to obtain the substituted data, or
an alternative static lookup table in the subfield of the finite field that statically stores all permutations needed to obtain the substituted data; and
routing the substituted data through one or more additional cryptographic stages to generate an output data.

2. The method of claim 1, wherein the cryptographic operation is an encryption operation, the input data is plaintext, and the output data is ciphertext.

3. The method of claim 1, wherein the cryptographic operation is a decryption operation, the input data is ciphertext, and the output data is plaintext.

4. The method of claim 1, wherein the combined data includes one or more of a portion of plaintext, a portion of masked plaintext, a value that is a function of plaintext, a value that is a function of masked plaintext, a portion of ciphertext, a portion of masked ciphertext, a value that is a function of ciphertext and a value that is a function of masked ciphertext.

5. The method of claim 1, wherein combining the input data with a round key includes routing the input data through an AddRoundKey stage of an AES cipher wherein each byte of an initial state of the input data is combined with a block of a round key.

6. The method of claim 5, wherein the cryptographic operation is an encryption operation and the substitution stage is a masked SubBytes stage operative to perform a non-linear substitution of bytes using the static lookup table that is its own inverse for encryption.

7. The method of claim 5, wherein the cryptographic operation is a decryption operation and the substitution stage is a masked InvSubBytes stage operative to perform a non-linear substitution of bytes using the static lookup table for decryption.

8. The method of claim 1 wherein the finite field is a Galois Field (GF) and the subfield is GF(2²).

9. The method of claim 8, wherein the substitution stage is operative to perform masked multiplicative inverse operations in GF(2²).

10. The method of claim 9, wherein the masked multiplicative inverse operations in GF(2²) exploit tower fields (GF(2²)²)² decomposed from GF(2⁸).

11. The method of claim 8, wherein the static lookup table that is its own inverse is one or more of [·]={00, 01, 10, 11} in GF(2²) and its permutations.

12. The method of claim 8, further including exploiting a dynamic lookup table of the substitution stage along with the static table that is its own inverse where the dynamic lookup table receives an input mask and an output mask and generates a masked table that corresponds to the static table that is its own inverse masked by the output mask with an index corrected by the input mask.

13. The method of claim 12, wherein the dynamic lookup table of the substitution stage is employed to determine low and high parts of a masked inverse in GF(2⁴).

14. A cryptographic device, comprising:
a processing circuit configured to
combine, as part of a cryptographic operation, input data with a round key to obtain combined data;
route at least a portion of the combined data through a substitution stage employing at least one of
a static lookup table that is its own inverse in a subfield of a finite field to obtain substituted data,
a dynamic lookup table in the subfield of the finite field where all substitution operations are implemented using permutations to obtain the substituted data, or
an alternative static lookup table in the subfield of the finite field that statically stores all permutations needed to obtain the substituted data; and
route the substituted data through one or more additional cryptographic stages to generate an output data; and
a storage device configured to store the output data.

15. The device of claim 14, wherein the cryptographic operation is an encryption operation, the input data is plaintext, and the output data is ciphertext.

16. The device of claim 14, wherein the cryptographic operation is a decryption operation, the input data is ciphertext, and the output data is plaintext.

17. The device of claim 14, wherein the combined data includes one or more of a portion of plaintext, a portion of masked plaintext, a value that is a function of plaintext, a value that is a function of masked plaintext, a portion of ciphertext, a portion of masked ciphertext, a value that is a function of ciphertext and a value that is a function of masked ciphertext.

18. The device of claim 14 wherein the finite field is a Galois Field (GF) and the subfield is GF(2²).

19. The device of claim 18, wherein the substitution stage is operative to perform masked multiplicative inverse operations in GF(2²).

20. A cryptographic device, comprising:
means for combining, as part of a cryptographic operation, input data with a round key to obtain combined data;
means for routing at least a portion of the combined data through a substitution stage employing at least one of a static lookup table that is its own inverse in a subfield of a finite field to obtain substituted data, a dynamic lookup table in the subfield of the finite field where all substitution operations are implemented using permutations to obtain the substituted data, or an alternative static lookup table in the subfield of the finite field that statically stores all permutations needed to obtain the substituted data; and
means for routing the substituted data through one or more additional cryptographic stages to generate an output data.

21. The device of claim 20, wherein the cryptographic operation is an encryption operation, the input data is plaintext, and the output data is ciphertext.

22. The device of claim 20, wherein the cryptographic operation is a decryption operation, the input data is ciphertext, and the output data is plaintext.

23. The device of claim 20, wherein the combined data includes one or more of a portion of plaintext, a portion of masked plaintext, a value that is a function of plaintext, a value that is a function of masked plaintext, a portion of ciphertext, a portion of masked ciphertext, a value that is a function of ciphertext and a value that is a function of masked ciphertext.

24. The device of claim 20 wherein the finite field is a Galois Field (GF) and the subfield is GF(2²).

25. The device of claim 24, wherein the substitution stage is operative to perform masked multiplicative inverse operations in GF(2²).

26. A machine-readable storage medium for use with cryptography, the machine-readable storage medium having one or more instructions which when executed by at least one processing circuit causes the at least one processing circuit to:
combine, as part of a cryptographic operation, input data with a round key to obtain combined data;
route at least a portion of the combined data through a substitution stage employing at least one of
a static lookup table that is its own inverse in a subfield of a finite field to obtain substituted data,
a dynamic lookup table in the subfield of the finite field where all substitution operations are implemented using permutations to obtain the substituted data, or
an alternative static lookup table in the subfield of the finite field that statically stores all permutations needed to obtain the substituted data; and
route the substituted data through one or more additional cryptographic stages to generate an output data.

27. The storage medium of claim 26, wherein the cryptographic operation is an encryption operation, the input data is plaintext, and the output data is ciphertext.

28. The storage medium of claim 26, wherein the cryptographic operation is a decryption operation, the input data is ciphertext, and the output data is plaintext.

29. The storage medium of claim 26, wherein the combined data includes one or more of a portion of plaintext, a portion of masked plaintext, a value that is a function of plaintext, a value that is a function of masked plaintext, a portion of ciphertext, a portion of masked ciphertext, a value that is a function of ciphertext and a value that is a function of masked ciphertext.

30. The storage medium of claim 26 wherein the finite field is a Galois Field (GF) and the subfield is GF(2²).
